(19) United States
(12) Patent Application Publication
(10) Pub. No.: US 2024/0414523 A1
(43) Pub. Date: Dec. 12, 2024

(54) TERMINAL DEVICE, FIRST NETWORK ELEMENT AND SECOND NETWORK ELEMENT

(71) Applicant: GUANGDONG OPPO MOBILE TELECOMMUNICATIONS CORP., LTD., Dongguan (CN)

(72) Inventors: Boren GUO, Dongguan (CN); Yang XU, Dongguan (CN); Jingran CHEN, Dongguan (CN)

(21) Appl. No.: 18/807,309

(22) Filed: Aug. 16, 2024

Related U.S. Application Data
(63) Continuation of application No. PCT/CN2022/077338, filed on Feb. 22, 2022.

(51) Int. Cl. H04W 8/24; H04W 60/00

(52) U.S. Cl. CPC H04W 8/24; H04W 60/00

(57) ABSTRACT

According to one aspect of the present disclosure, a terminal device is provided. The terminal device includes a transceiver, a memory configured to store executable instructions, and a processor configured to execute the executable instructions stored in the memory to cause the transceiver to receive an Artificial Intelligence (AI) service data sent by a first network element serving the terminal device. The AI service data is sent by a second network element to the first network element based on an identification information of first network element. A core network element sends AI service data to a terminal device through the first network element, so that the core network element can send AI service data such as an AI or Machine Learning (ML) model, analysis result, metadata, intermediate results of model training, raw data, etc., to achieve sending analysis result and federal learning, thereby enriching the application scenarios of AI service.

### CROSS-REFERENCE TO RELATED APPLICATIONS

This application is a continuation of International Application No. PCT/CN2022/077338, filed on Feb. 22, 2022, the entire contents of which are incorporated herein by reference.

### TECHNICAL FIELD

This disclosure relates to the field of communication, and in particularly refers to terminal device, first network element and second network element.

### BACKGROUND

In the related technical field, AI service data can only be transmitted inside a core network, and a Network Data Analytics Function (NWDAF) network element sends the analysis results of the AI service, to an Application Function (AF) network element to implement the transmission of the AI service data.

Therefore, further research is needed for the transmission of AI service data.

### SUMMARY

Embodiments of the present disclosure provide a terminal device, a first network element and a second network element.

According to an aspect of an embodiment of the present disclosure, a terminal device is provided. The terminal device includes a transceiver, a memory configured to store executable instructions, and a processor configured to execute the executable instructions stored in the memory to cause the transceiver to receive an Artificial Intelligence (AI) service data sent by a first network element serving the terminal device, where the AI service data is sent by a second network element to the first network element based on first identification information of first network element.

According to an aspect of an embodiment of the present disclosure, a first network element is provided. The first network element includes a transceiver, a memory configured to store executable instructions, and a processor configured to execute the executable instructions stored in the memory to cause the transceiver to obtain an Artificial Intelligence (AI) service data and second identification information of terminal device from a second network element, send the AI service data to the terminal device based on the identification information of terminal device.

According to an aspect of an embodiment of the present disclosure, a second network element is provided. The second network element includes a transceiver, a memory configured to store executable instructions, and a processor configured to execute the executable instructions stored in the memory to cause the transceiver to obtain an identification information of first network element serving a terminal device, send an Artificial Intelligence (AI) service data to the first network element based on an identification information of first network element, where the AI service data is sent by the first network element to the terminal device.

### BRIEF DESCRIPTION OF THE DRAWINGS

FIG. 1 is a system architecture diagram of a communication system according to an embodiment of the present disclosure;

FIG. 2 is a system architecture diagram of a 5G system according to an embodiment of the present disclosure.

FIG. 3 is a system architecture diagram of a 5G system according to another embodiment of the present disclosure.

FIG. 4 is a schematic flowchart of a method for AI service data transmission according to an embodiment of the present disclosure;

FIG. 5 is a schematic flowchart of a method for AI service data transmission according to another embodiment of the present disclosure;

FIG. 6 is a schematic flowchart of a method for AI service data transmission according to another embodiment of the present disclosure;

FIG. 7 is a schematic flowchart of a method for AI service data transmission according to another embodiment of the present disclosure;

FIG. 8 is a schematic flowchart of a method for AI service data transmission according to another embodiment of the present disclosure;

FIG. 9 is a schematic flowchart of a method for AI service data transmission according to another embodiment of the present disclosure;

FIG. 10 is a schematic flowchart of a method for AI service data transmission according to another embodiment of the present disclosure;

FIG. 11 is a schematic block diagram of apparatus for AI service data transmission according to an embodiment of the present disclosure.

FIG. 12 is a schematic block diagram of apparatus for AI service data transmission according to another embodiment of the present disclosure.

FIG. 13 is a schematic block diagram of apparatus for AI service data transmission according to another embodiment of the present disclosure.

FIG. 14 is a schematic block diagram of apparatus for AI service data transmission according to another embodiment of the present disclosure.

FIG. 15 is a schematic structural diagram of terminal device according to an embodiment of the present disclosure.

FIG. 16 is a schematic structural diagram of network device according to an embodiment of the present disclosure.

### DETAILED DESCRIPTION

To more clearly describe the purposes, technical solutions and advantages of the present disclosure. The technical solutions in some embodiments of the present disclosure will be described below in combination with the drawings in some embodiments of the present disclosure.

The network architecture as well as the service scenarios described in some embodiments of the present disclosure are for the purpose of more clearly illustrating the technical solutions of the embodiments of the present disclosure, and do not limit the technical solutions provided by the embodiments of the present disclosure. A person of ordinary skill in the art may know that with the evolution of the network architecture and the emergence of new service scenarios, the technical solutions provided by the embodiments of the present disclosure are suitable for solving similar technical problems.

The technical solutions in some embodiments of the disclosure may be applied to various communication systems, such as: a Global System of Mobile communication (GSM) system, a Code Division Multiple Access (CDMA) system, a Wideband Code Division Multiple Access (WCDMA) system, a General Packet Radio Service (GPRS), a Long Term Evolution (LTE) system, an Advanced long term evolution (LTE-A) system, a New Radio (NR) system, an evolved NR system, an LTE-based access to unlicensed spectrum (LTE-U) system, an NR-based access to unlicensed spectrum (NR-U) system, a Non-Terrestrial Network (NTN) system, a Universal Mobile Telecommunication System (UMTS), a Wireless Local Area Network (WLAN), a Wireless Fidelity (WiFi), a 5G system or other communication systems.

In general, a traditional communication system supports a limited number of connections and is easy to be implemented. However, with the development of communication technologies, a mobile communication system will not only support the traditional communication, but also support, for example, a Device to Device (D2D) communication, a Machine to Machine (M2M) communication, a Machine Type Communication (MTC), a Vehicle to Vehicle (V2V) communication, or a Vehicle to everything (V2X) communication, etc. The embodiments of the present disclosure may also be applied to these communication systems.

The communication system in some embodiments of the present disclosure may be applied to a Carrier Aggregation (CA) scenario, a Dual Connectivity (DC) scenario, or a Standalone (SA) network deployment scenario.

The communication system in embodiments of the present disclosure may be applied to unlicensed spectrum, where the unlicensed spectrum may also be considered shared spectrum; or the communication system in embodiments of the present disclosure may also be applied to licensed spectrum, where the licensed spectrum may also be considered unshared spectrum.

Embodiments of the present disclosure may be applied to Non-Terrestrial Networks (NTN) systems or to Terrestrial Networks (TN) systems.

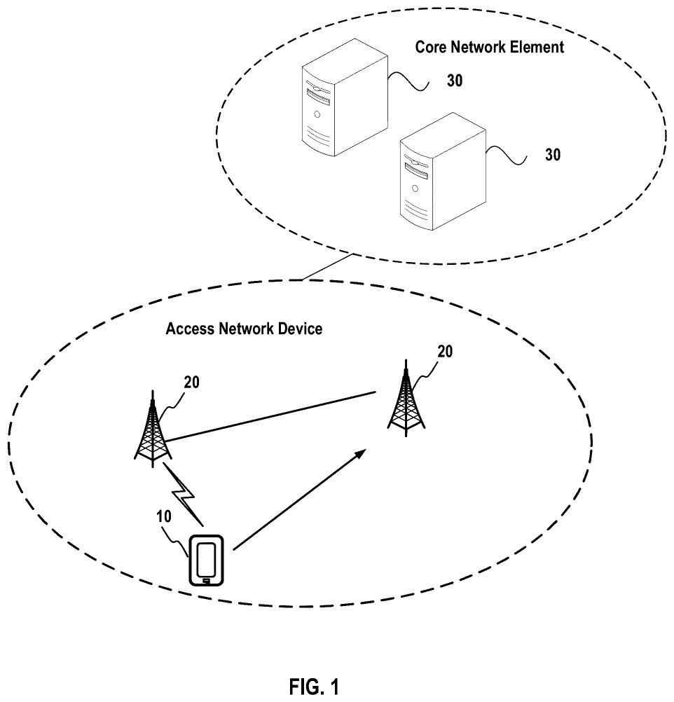

FIG. 1 illustrates a schematic diagram of a network architecture provided by an embodiment of the present disclosure. The network architecture may include: a terminal device 10, an access network device 20, and a core network element 30.

The terminal device 10 may be referred to as User Equipment (UE), an access terminal, a user unit, a user station, a mobile station, a mobile platform, a remote station, a remote terminal, a mobile device, a wireless communication device, a user agent, or a user device. In some embodiments of the disclosure, The terminal device 10 may be a cellular telephone, a cordless phone, a Session Initiation Protocol (SIP) phone, a Wireless Local Loop (WLL) station, a Personal Digital Processing (PDA) device, a handheld device with a wireless communication function, a computing device or other processing device connected to a wireless modem, a vehicle-mounted device, a wearable device, a terminal device in a next generation communication system such as an NR network, or a terminal device in a future evolved Public Land Mobile Network (PLMN), and so on, and embodiments of the present disclosure do not impose specific limitations on this. For convenience of description, the devices mentioned above are collectively referred to as terminal device. The number of terminal devices 10 is usually a plurality. One or more terminal devices 10 may be distributed in the cell managed by each access network device 20. In some embodiments of the present disclosure, “terminal device” and “UE” are usually used interchangeably, but a person of ordinary skill in the art may understand their meanings.

The access network device 20 is a device deployed in the access network to provide wireless communication functions for the terminal device 10. The access network device 20 may include various forms of macro base stations, micro base stations, relay stations, access points, etc. In systems using different wireless access technologies, the names of devices with access network device functions may be different. For example, in 5G NR systems, they are called gNodeB or gNB. As communication technology evolves, the name “access network equipment” may change. For convenience of description, in the embodiment of the present disclosure, the above-mentioned devices that provide wireless communication functions for the terminal device 10 are collectively referred to as access network devices. In some embodiments, a communication relationship can be established between the terminal device 10 and the core network element 30, through the access network device 20. For example, in a Long Term Evolution (LTE) system, the access network device 20 may be Evolved Universal Terrestrial Radio Access Network (EUTRAN) or one or more eNodeBs in EUTRAN; In the 5G NR system, the access network device 20 may be a Radio Access Network (RAN) or one or more gNBs in the RAN.

The core network element 30 is a network element deployed in the core network. The functions of the core network element 30 are mainly to provide user connections, manage users and complete the bearer of the services, and serve as an interface provided by the bearer network to the external network. For example, the core networks in the 5G NR system can include Access and Mobility Management Function (AMF), User Plane Function (UPF) and Session Management Function (SMF), and other network elements. In addition, core networks can be regarded as functional entities, and one or more core networks can be deployed on a physical device.

In some embodiments, the access network device 20 and the core network element 30 communicate with each other through some air interface technology, such as the NG interface in the 5G NR system. The access network device 20 and the terminal device 10 communicate with each other through some air interface technology, such as the Uu interface.

The “5G NR system” in the embodiment of the present disclosure may also be called a 5G system or an NR system, but a person of ordinary skill in the art can understand its meaning. The technical solutions described in some embodiments of the present disclosure can be applied to LTE systems, 5G NR systems, subsequent evolution systems of the 5G NR system, applications such as Narrow Band Internet of Things (NB-IoT) systems or other communication systems, and embodiments of the present disclosure do not impose specific limitations on this.

In an embodiment of the present disclosure, the access network device may provide services for a cell, and the terminal device communicates with the access network device through the transmission resources (e.g., frequency domain resources, or, in other words, spectrum resources) on the carrier used by the cell, which may be the cell corresponding to the access network device (e.g., the base station), and the cell may belong to a macro base station, or it may belong to the base station corresponding to a small cell. The small cell here may include: Metro cell, Micro cell, Pico cell, Femto cell, etc. These small cells are characterized by small coverage area and low transmit power, and are suitable for providing high speed data transmission services.

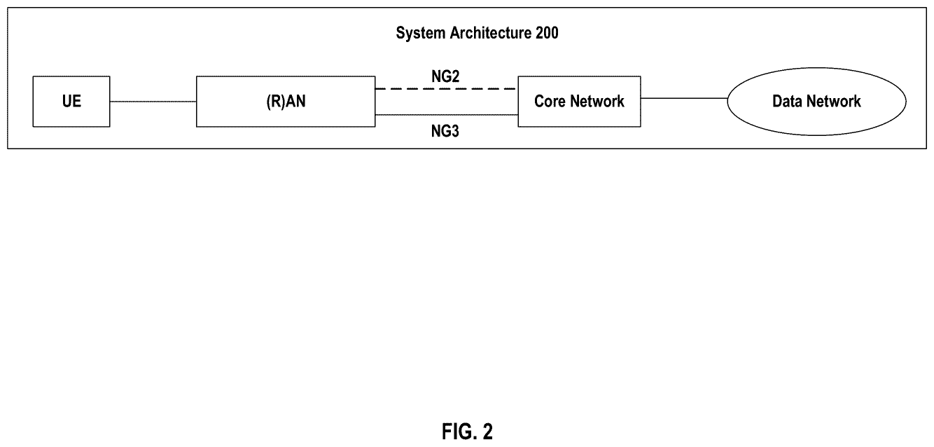

Referring to FIG. 2, which shows a system architecture of a 5th Generation System (5GS) provided by embodiments of the present disclosure. As shown in FIG. 2, the system architecture 200 may include: a UE (i.e., a “terminal device” as described above), an (Radio) Access Network ((R)AN), a Core Network, and a Data Network (DN). Among them, UE, (R)AN, and Core Network are the main components of the architecture, which can be logically categorized into two parts, user plane and control plane, where the control plane is responsible for the management of the mobile network and the user plane is responsible for the transmission of service data. In the FIG. 2, the NG2 reference point is located between the (R)AN control plane and the Core Network control plane, the NG3 reference point is located between the (R)AN user plane and the Core Network user plane, and the NG6 reference point is located between the Core user plane and the data network.
UE: It is the entrance for mobile users to interact with the network. It can provide basic computing capabilities and storage capabilities, display service windows to users, and receive user operation inputs. The UE will use next-generation air interface technology to establish signal connections and data connections with (R)AN to transmit/receive control signals and service data to/from the mobile network.
(R)AN: Similar to base stations in traditional networks, it is deployed close to the UE to provide network access functions for authorized users in specific areas, and can use transmission tunnels of different qualities to transmit user data according to user levels, service needs, etc., (R)AN can manage its own resources, utilize them rationally, provide access services to UEs on demand, and forward control signals and user data between UEs and the core network.
Core Network: It is responsible for maintaining the contracted data of the mobile network, managing the network elements of the mobile network, and providing the UE with functions such as session management, mobility management, policy management, and security authentication. When the UE is attached, it provides the UE with entry authentication; when the UE has service requests, it allocates network resources for the UE. When the UE is moving, it updates network resources for the UE. When the UE is idle, it provides the UE with a fast recovery mechanism: when the UE is de-attached, it releases the network resources for the UE. When the UE has service data, it provides the UE with data routing functions for the UE, such as forwards the uplink data to the DN, or receive UE downlink data from the DN and sends to the UE via the (R)AN.
DN: It is a data network that provides service to users. Generally, the client is located in the UE and the server is located in the data network. The data network can be a private network, such as a Local Area Network (LAN), or an external network that is not controlled by the operator, such as the Internet, or a proprietary network jointly deployed by the operator, such as for configuring IP Multimedia Core Network Subsystem (IMS) services.

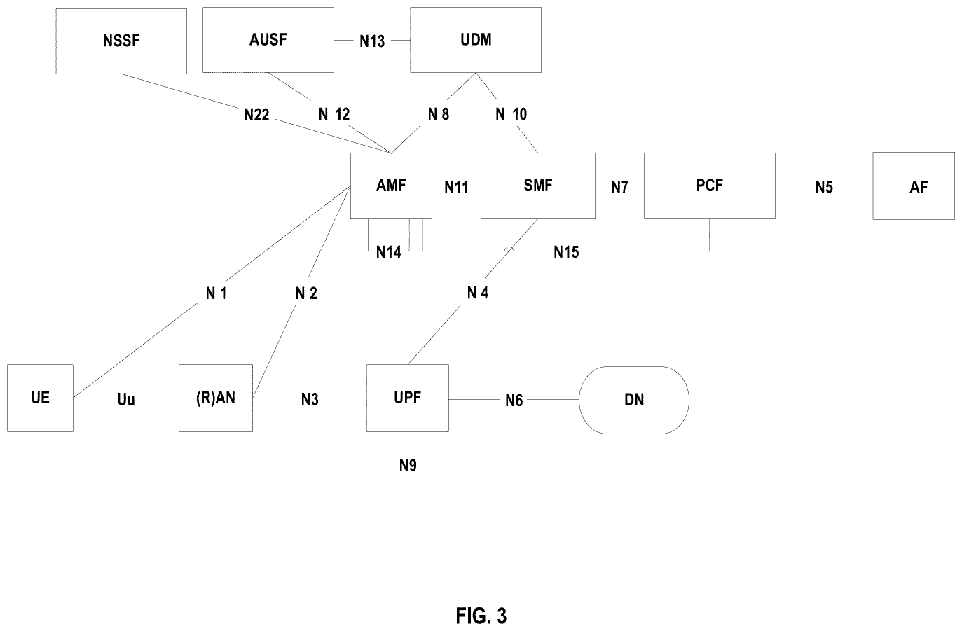

FIG. 3 shows the detailed architecture determined on the basis of FIG. 2. The core network user plane includes User Plane Function (UPF). The core network control plane includes Authentication Server Function (AUSF), AMF, SMF, Network Slice Selection Function (NSSF), Network Exposure Function (NEF), Network Repository Function (NRF), Unified Data Management (UDM), Policy Control Function (PCF), and Application Function (AF).

In the architecture shown in FIG. 3, the UE connects with the (R)AN via the Uu interface for Access Stratum (AS) to interact with AS messages and wireless data transmission, and the UE connects with the AMF via the N1 interface for Non Access Stratum (NAS) to interact with NAS messages, the AMF is the Mobility Management Function in the Core Network. AMF is the mobility management function in the core network, SMF is the session management function in the core network, AMF is responsible for forwarding session management related messages between UE and SMF in addition to mobility management for UE, PCF is the policy management function in the core network, it is responsible for formulating the policies related to UE mobility management, session management, charging. UPF is the user plane function in the core network, it is responsible for data transmission to the external data network through N6 interface, and it is responsible for the data transmission to the external data network through N3 interface,

It should be noted that the names of the interfaces between the individual network elements in FIG. 2 and FIG. 3 are only an example, and the names of the interfaces in the specific implementation may be other names, and the embodiments of the present disclosure do not specifically limit this. The names of the individual network elements (e.g., SMF, AF, UPF, etc.) included in FIG. 2 and FIG. 3 are also only an example, and do not constitute a limitation on the function of the network elements themselves. In 5GS and other future networks, the individual network elements described above may also have other names, and the embodiments of the present disclosure do not specifically limit this. For example, in a 6G network, some or all of the above-described individual network elements may follow the terminology used in 5G, or may adopt other names, etc., which will be described uniformly here and will not be described in detail below. Furthermore, it should be understood that the names of the above-mentioned messages (or signaling) transmitted between various network elements are only an example and does not constitute any limitation on the function of the messages themselves.

In the current 3rd Generation Partnership Project (3GPP) network, AI service data can only be transmitted inside the core network and cannot be sent down from the core network element to the terminal device. The present disclosure implements a transmission method in which AI service data is sent from the core network element to the terminal device by forwarding the AI service data sent by the core network element to the terminal device through a first network element.

In the following, the technical solution of the present disclosure will be introduced and explained through several embodiments.

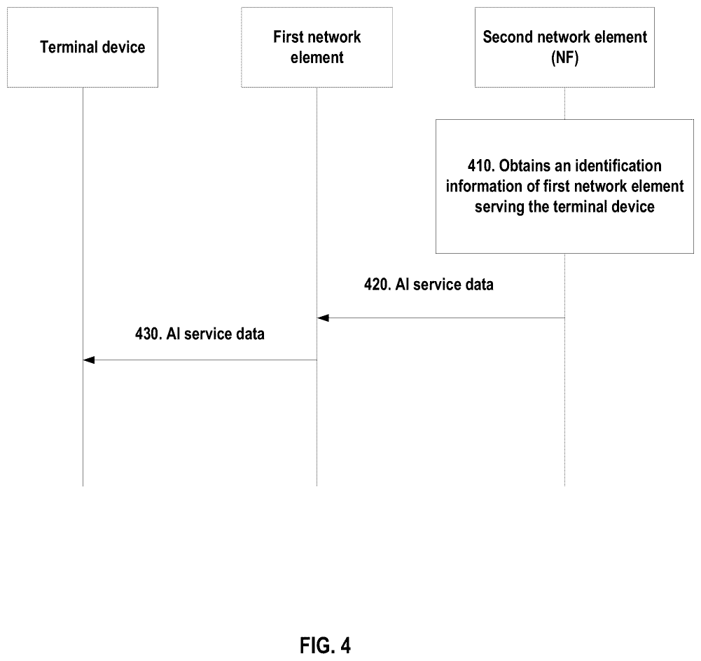

FIG. 4 illustrates a schematic flowchart of an AI service data transmission method of an embodiment of the present disclosure. The method may be applied in the system architecture presented in FIG. 1 to FIG. 3 above. The method may include at least one of the following steps (410 to 430).
Step 410, a second network element obtains an identification information of the first network element serving the terminal device.

In some embodiments, the second network element is a Network Function (NF). For example, the second network element is a NF on the core network side, i.e., the second network element may be referred to as a core network element. For example, the second network element may be NWDAF or a new network element that will appear in the future with AI model training or analysis processing capabilities.

In some embodiments, the first network element may be a core network element, or may not be a core network element. For example, the first network element may be a non-core network element provided by a third-party manufacturer or service provider.

In some embodiments, the first network element is a trusted network element or an untrusted network element, where the trusted network element is a network element that is set by the operator to be considered trustworthy, and the untrusted network element is a network element that is outside of the operator's settings. In addition, the first network element may be an existing network element in the current core network, such as a Data Collection AF (DCAF) network element, or the first network element may be a newly added network element in the core network, such as a newly added AF network element. Whether the first network element is the trusted network element or the untrusted network element, it depends on the deployment strategy of the operator and is independent of the type of the first network element. For example, in the case where the first network element is a DCAF, the operator may regard it as the trusted network element or the untrusted network element; or, in the case where the first network element is another AF, the operator may regard it as the trusted network element or the untrusted network element.

The identification information of the first network element is used to uniquely identify the first network element. In some embodiments, the identification information of the first network element includes, but is not limited to, at least one of: Identification (ID) of the first network element, address of the first network element, or Uniform Resource Locator (URL) of the first network element. In an embodiment of the present disclosure, the address of the first network element is different from the service area of the first network element. The address of the first network element refers to a communication address of the first network element, and other network elements sending information to the first network element may send information to the first network element based on the address of the first network element. The service area of the first network element is an area in which that the first network element provides services, such as a certain geographic location area or a certain neighborhood.

In some embodiments, the second network element obtains the identification information of the first network element based on the identification information of the terminal device. The identification information of the terminal device is used to uniquely identify the terminal device, and the terminal device and the identification information of the terminal device are in a unique correspondence. For example, the identification information of the terminal device includes, but is not limited to, at least one of: SUbscription Permanent Identifier (SUPI), Subscription Concealed Identifier (SUCI), group Identification (group ID), or Generic Public Subscription Identifier (GPSI). In some embodiments, the SUPI and the SUCI are an internal identification information of the terminal device. In some embodiments, the group ID may include an internal group ID and an external group ID, where the internal group ID is the internal identification information of the terminal device, and the external group ID is the external identification information of the terminal device. In some embodiments, the GPSI is usually used as the external identification information of the terminal device, but in some cases, it can also be used as the internal identification information of the terminal device. The above-mentioned internal identification information of the terminal device is the identification information used by the terminal device inside the core network, and the external identification information of the terminal device is the identification information used by the terminal device outside the core network.

In some embodiments, the second network element obtains the identification information of the first network element based on the location information of the terminal device. The location information of the terminal device is a specific area or geographic location, and the terminal device and the location information of the terminal device are in a unique correspondence. For example, the location information of the terminal device includes, but is not limited to, at least one of: Area-of-Interest (AoI), Tracking Area Indicator (TAI), or cell identity.

In addition, the first network element serving the terminal device is the first network element that establishes a connection with the terminal device. For example, the first network element establishes HyperText Transfer Protocol (HTTP) connection with the terminal device.
Step 420, the second network element sends the AI service data to the first network element based on the identification information of the first network element.

If the second network element sends AI service data to the terminal device, it first obtains the identification information of the first network element serving the terminal device. After obtaining the identification information of the first network element, it can send the AI service data to the first network element.

In some embodiments, the second network element, while sending the AI service data, also sends the identification information of the terminal device to the first network element, thereby informing the first network element to which terminal device(s) it needs to send the AI service data. Accordingly, the first network element obtains the AI service data and the identification information of the terminal device from the second network element.

In some embodiments, the AI service data is sent by the second network element to the first network element based on the identification information of the first network element.

In some embodiments, the AI service data includes, but is not limited to, at least one of: AI or Machine Learning (ML) model, analysis result, metadata, intermediate results of model training, or raw data. The AI or ML model is a model to analyze a certain service. For example, it may be a model based on a neural network, and above model can be trained through the ML algorithm. Analysis result is a result of model analysis, such as the result obtained by analyzing a certain service using the trained model. Metadata is the data that describes the original data, e.g., metadata can be the information that describes the attributes of the original data, which achieves the purpose of assisting data retrieval. Intermediate results of model training are a model parameters obtained during the modeling process, such as the weight parameters or gradient parameters of the neural network. Raw data is the training data of the model, which is used to construct the training samples or test samples required for model training.
Step 430, the first network element sends the AI service data to the terminal device based on the identification information of the terminal device.

In some embodiments, after receiving the AI service data and the identification information of the terminal device, the first network element forwards the AI service data to the terminal device based on the identification information of the terminal device. Accordingly, the terminal device receives the AI service data sent by the first network element.

In some embodiments, the identification information of the terminal device is used for the first network element to send the AI service data to the terminal device.

In one application scenario, a core network element runs the AI model to obtain corresponding analysis result. If the core network element needs to provide the analysis result to the terminal device, the technical solution of the present disclosure may be adopted to determine the first network element serving the terminal device, and then forward the analysis result to the terminal device through the first network element.

In another application scenario, the core network element needs multiple terminal devices to assist in AI model training to achieve the purpose of federated learning. In this scenario, the core network element needs to send the initialized AI model or the intermediate results of model training to one or more terminal devices. Adopting the technical solution of the present disclosure, one or more first network elements serving the above-mentioned terminal device are first determined, and then through the one or more first network elements forwards the initialized AI model or the intermediate results of model training to the corresponding terminal devices.

The above application scenarios are only exemplary and explanatory, and the technical solution of the present disclosure may also be applied in other application scenarios that require the core network elements to send AI service data to the terminal device, and the present disclosure does not limit this.

The technical solution provided by the embodiments of the present disclosure implements a data transmission method for the core network element to send AI service data to the terminal device through the first network element, so that the core network element can send down AI service data such as AI or ML models, analysis result, metadata, intermediate results of model training, and raw data, so as to implements the functions of sending analysis result and federal learning, and to enrich the application scenarios of AI service.

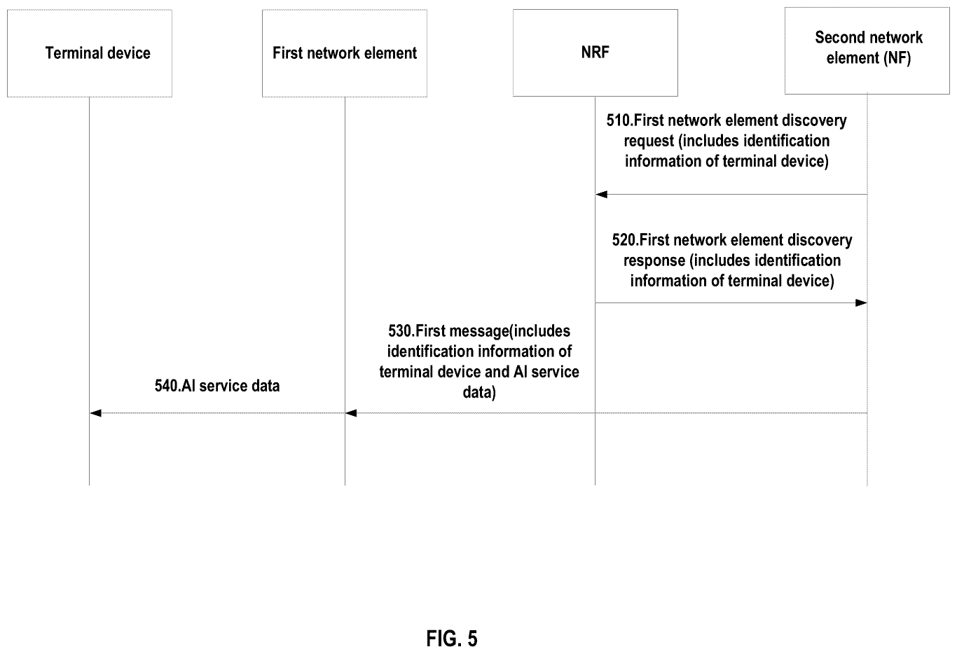

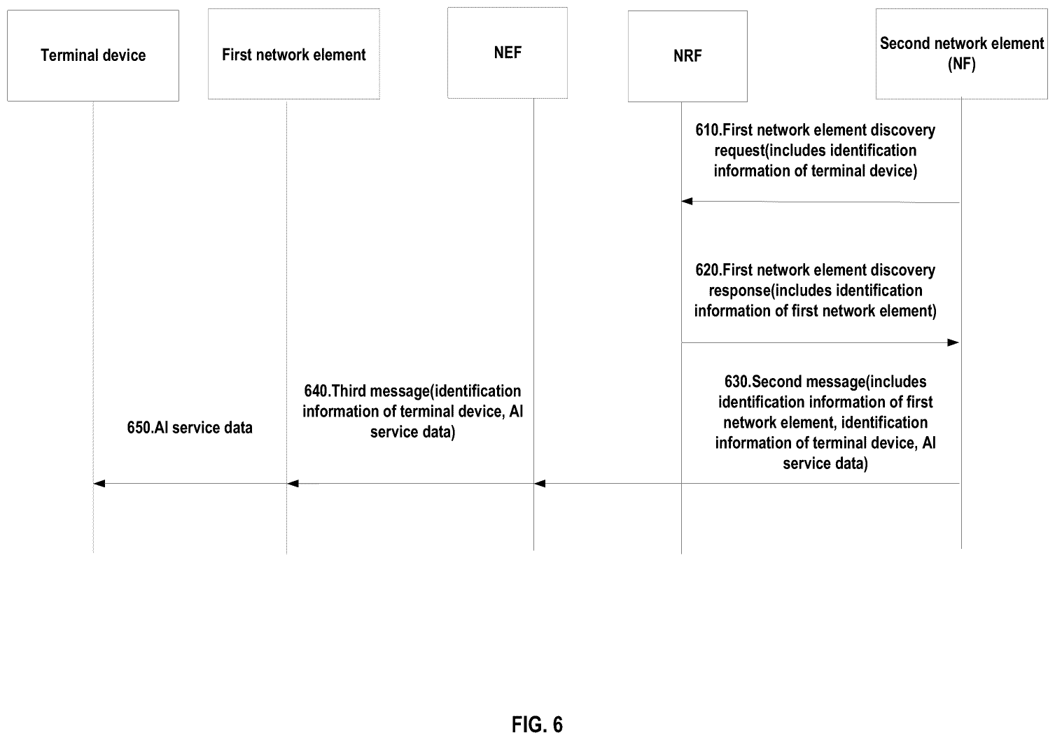

In another embodiments, the second network element may obtain the identification information of the first network element based on the identification information of the terminal device, or may obtain the identification information of the first network element based on the location information of the terminal device. Hereinafter, through the embodiments shown in FIG. 5 and FIG. 6, the following takes the second network element to obtain the identification information of the first network element based on the identification information of the terminal device as an example to introduce and explain the technical solution of the present disclosure. For details not described in detail in the embodiments shown in FIG. 5 and FIG. 6, reference may be made to the description in other embodiments in the context. In the embodiment shown in FIG. 5, the first network element is a trusted network element, and the embodiment shown in this FIG. 5 introduces a process of sending AI service data when the first network element is the trusted network element. In the embodiment shown in FIG. 6, the first network element is an untrusted network element, and the embodiment shown in that FIG. 6 introduces a process of sending AI service data when the first network element is the untrusted network element.

FIG. 5 illustrates a schematic flowchart of an AI service data transmission method provided by another embodiment of the present disclosure. This method can be applied to the system architecture introduced in FIG. 1 to FIG. 3 above. The method may include at least one of the following steps (510 to 540).

In this embodiment, the first network element is a trusted network element.
Step 510: a second network element sends a first network element discovery request to the NRF.

In some embodiments, the second network element is a NF. For example, the second network element is a NF on the core network side, i.e., the second network element may be referred to as a core network element.

In some embodiments, the second network element invokes a first service to send the first network element discovery request to the NRF using the first service. The second network element uses the first service to implement step 510. For example, the first service may be referred to as Nnrf_NFDiscovery_Request.

In some embodiments, the first network element discovery request includes the identification information of the terminal device. In some embodiments, the identification information of the terminal device and the identification information of the first network element are mapped.

In some embodiments, the identification information of the terminal device included in the first network element discovery request is the internal identification information of the terminal device, where the internal identification information of the terminal device is identification information used by the terminal device inside the core network. For example, the internal identification information of the terminal device includes, but is not limited to, at least one of: SUPI, SUCI, or internal group ID.

In some embodiments, the first network element discovery request further includes first network element indication information. It should be noted that the first network element indication information is not the identification information of the first network element, and the first network element indication information indicates which type of network element the NRF discovers. For example, the first network element indication information is a name of the first network element, which is used to inform the NRF that discovery object is the first network element.

In some embodiments, after receiving the first network element discovery request, the NRF queries the locally stored registration information to find the identification information of the first network element that has a mapping relationship with the identification information of the terminal device. The NRF is used to store the identification information of the terminal device, the identification information of the first network element, and the mapping relationship between the identification information of the terminal device and the identification information of the first network element. After querying the identification information of the first network element that has a mapping relationship with the identification information of the terminal device, the NRF may send a first network element discovery response to the second network element.
Step 520, the second network element receives the 3 sent by the NRF.

In some embodiments, the first network element discovery response includes an identification information of the first network element, where the identification information of the first network element is information of the first network element having a mapping relationship to the identification information of the terminal device obtained from the first registration information. For example, the identification information of the first network element includes, but is not limited to, at least one of: ID of the first network element, address of the first network element, or URL of the first network element.

In some embodiments, the first network element discovery response further includes the identification information of the terminal device. For example, the first network element discovery response includes the identifying information of the first network element and the identification information of the terminal device.

In some embodiments, the NRF provides the identification information of the first network element serving the terminal device to the second network element, and the identification information of the first network element is used for the second network element to send the AI service data to the first network element, and the AI service data is sent by the first network element to the terminal device.
Step 530, the second network element sends the first message to the first network element based on the identification information of the first network element.

In some embodiments, the identification information of the first network element is used for the second network element to send the first message to the first network element. Accordingly, the first network element receives the first message sent by the second network element. In some embodiments, the first message includes the identification information of the terminal device and the AI service data.

In some embodiments, the second network element invokes a second service to send the first message to the first network element using the second service. The second network element uses the second service to implement step 530. For example, the second service may be referred to as Nnf_DataManagement_Notify.
Step 540, the first network element sends the AI service data to the terminal device based on the identification information of the terminal device.

In some embodiments, the identification information of the terminal device is used for the first network element to send the AI service data to the terminal device.

Accordingly, the terminal device receives the AI service data sent by the first network element serving the terminal device, and the AI service data is sent by the second network element to the first network element based on the identification information of the first network element.

In some embodiments, the first network element invokes a third service to send the AI service data to the terminal device using the third service. The first network element uses the third service to implement step 540. For example, the third service may be referred to as Naf_DataManagement_Notify.

In some embodiments of the present disclosure, the names regarding the individual services (e.g., the first service, the second service, the third service, etc.) are only exemplary and explanatory, and different names may be set in practical applications, which are not limited by the present disclosure. In embodiments of the present disclosure, the above-mentioned second service (e.g., Nnf_DataManagement_notify) and the third service (e.g., Naf_DataManagement_Notify) are for implementing the operation of the newly constructed service of the present method.

The present embodiment provides an implementation method of the second network element to obtain the identification information of the first network element based on the identification information of the terminal device, and describes a process of sending AI service data in the case where the first network element is the trusted network element.

FIG. 6 illustrates a schematic flowchart of an AI service data transmission method provided by another embodiment of the present disclosure. The method may be applied in the system architecture presented in FIG. 1 to FIG. 3 above. The method may include at least one of the following steps (610 to 650).

In this embodiment, the first network element is an untrusted network element.
Step 610, second network element sends a first network element discovery request to the NRF.

In some embodiments, the second network element is a NF. For example, the second network element is a NF on the core network side, i.e., the second network element may be referred to as a core network element.

In some embodiments, the second network element invokes a first service to send a first network element discovery request to the NRF using the first service. The second network element use the first service to implement step 610. For example, the first service may be referred to as Nnrf_NFDiscovery_Request.

In some embodiments, the first network element discovery request includes the identification information of the terminal device. In some embodiments, the identification information of the terminal device is the internal identification information of the terminal device, where the internal identification information of the terminal device is identification information used by the terminal device inside the core network. For example, the identification information of the terminal device includes, but is not limited to, at least one of: SUPI, SUCI, or internal group ID.

In some embodiments, the first network element discovery request further includes first network element indication information. It should be noted that the first network element indication information is not the identification information of the first network element, and the first network element indication information indicates which type of network element the NRF discovers. For example, the first network element indication information is a name of the first network element, which is used to tell the NRF that discovery object is the first network element.

Correspondingly, after receiving the first network element discovery request, the NRF queries the locally stored registration information to find the identification information of the first network element that has a mapping relationship with the identification information of the terminal device and a Network Exposure Function (NEF) serving the corresponding first network element. The NRF is used to store the identification information of the terminal device, the identification information of the first network element, the mapping relationship between the identification information of the terminal device and the identification information of the first network element, and an identification information of the NEF serving the untrusted first network element. After querying the identification information of the first network element that has a mapping relationship with the identification information of the terminal device, the NRF may send the first network element discovery response to the second network element.
Step 620, the second network element receives the first network element discovery response sent by the NRF.

In some embodiments, when the first network element is the untrusted network element, the first network element discovery response further includes the identification information of the NEF.

In some embodiments, the first network element discovery response includes the identification information of the first network element and the identification information of the NEF serving the untrusted first network element, where the identification information of the first network element is information of the first network element having a mapping relationship to the identification information of the terminal device obtained from the first network element discovery response. For example, the identification information of the first network element includes, but is not limited to, at least one of: ID of the first network element, address of the first network element, or URL of the first network element.
Step 630, the second network element sends the second message to the NEF.

In some embodiments, the second network element sends the second message to the corresponding NEF based on the identification information of the NEF in the first network element discovery response. In some embodiments, the identification information of the NEF includes, but is not limited to, at least one of: ID of the NEF, address of the NEF, or URL of the NEF.

In some embodiments, the second message includes the identification information of the first network element, the identification information of the terminal device, and the AI service data.

In some embodiments, the identification information of the first network element is used for the second network element to send the second message to the NEF, and is used for the NEF to send the third message to the first network element.

The NEF sends the third message to the first network element based on the identification information of the first network element. The third message includes the identification information of the terminal device and the AI service data.

In some embodiments, the identification information of the terminal device included in the second message is the internal identification information of the terminal device, where the internal identification information of the terminal device is identification information used by the terminal device inside the core network. For example, the internal identification information of the terminal device includes, but is not limited to, at least one of: SUPI, SUCI, or internal group ID. Correspondingly, the NEF maps the internal identification information of the terminal device to the external identification information of the terminal device.

In some embodiments, the AI service data in the second message includes internal AI service data, the NEF is further used to map the internal AI service data to an external AI service data and send the external AI service data in the third message to the first network element. For example, the internal AI service data is the AI service data transmitted inside the core network, the external AI service data is the AI service data transmitted outside the core network. The internal AI service data and the external AI service data may be converted to each other, such as format conversion or other aspects of conversion. In some embodiments, NEF maps internal AI service data to external AI service data, and send the external AI service data in the third message to the first network element.
Step 640, the first network element receives the third message sent by the NEF.

In some embodiments, the third message includes the identification information of the terminal device and the AI service data.

In some embodiments, the NEF invokes a fourth service to send the third message to the first network element, and the NEF use the fourth service to implement step 640. For example, the fourth service may be referred to as Nnef_EventExposure_Notify or Nnef_AnalyticExposure_Notify.

In some embodiments, the identification information of the terminal device included in the third message is the external identification information of the terminal device, where the external identification information of the terminal device is identification information used by the terminal device outside of the core network. For example, the external identification information of the terminal device includes, but is not limited to, at least one of: GPSI, or external group ID.
Step 650, the first network element sends the AI service data to the terminal device based on the identification information of the terminal device.

In some embodiments, the identification information of the terminal device is used for the first network element to send the AI service data to the terminal device.

Accordingly, the terminal device receives the AI service data sent by the first network element serving the terminal device, and the AI service data is sent by the second network element to the first network element based on the identification information of the first network element. In some embodiments, the first network element invokes a third service to send the AI service data to the terminal device using the third service, and the first network element uses the third service to implement step 650. For example, the third service may be referred to as Naf_DataManagement_Notify.

In some embodiments of the present disclosure, the names regarding the individual services (e.g., the first service, the fourth service, the third service, etc.) are only exemplary and explanatory, and different names may be set in practical applications, which are not limited by the present disclosure.

This embodiment provides an implementation method for a second network element to obtain the identification information of the first network element based on the identification information of the terminal device, and describes a process of sending AI service data in the case where the first network element is the trusted network element.

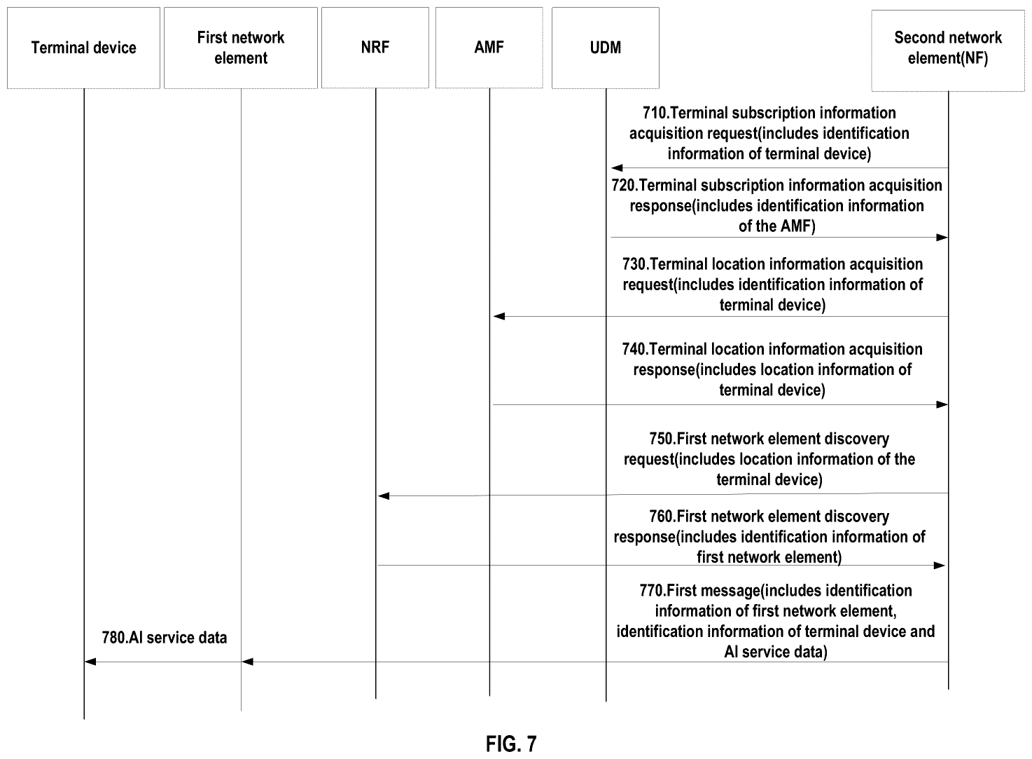

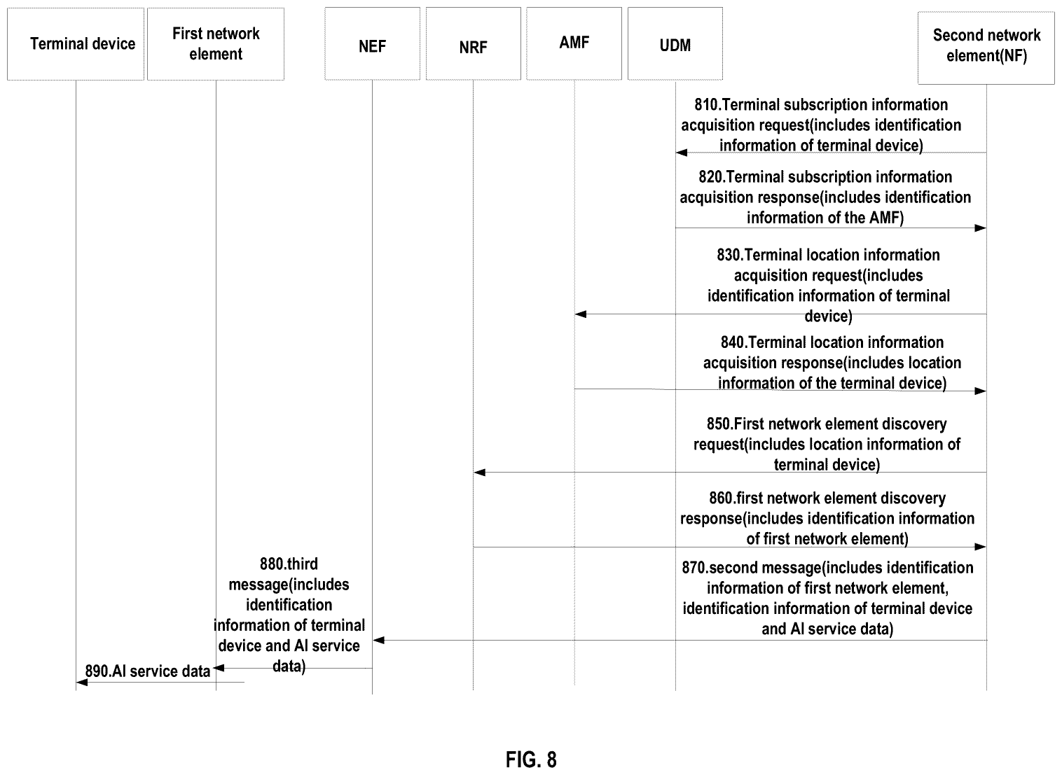

In another embodiment, the second network element may obtain the identification information of the first network element based on the identification information of the terminal device, or may obtain the identification information of the first network element based on the location information of the terminal device. Hereinafter, through the embodiments shown in FIG. 7 and FIG. 8, the following takes the second network element to obtain the identification information of the first network element based on the identification information of the terminal device as an example to introduce and explain the technical solution of the present disclosure. For details not described in detail in the embodiment shown in FIG. 7 and FIG. 8, reference may be made to the introductory description in other embodiments in the context. In the embodiment shown in FIG. 7, the first network element is a trusted network element, and the embodiment shown in that FIG. 7 introduces a process of sending AI service data when the first network element is the trusted network element. In the embodiment shown in FIG. 8, the first network element is an untrusted network element, and the embodiment shown in that FIG. 8 introduces a process of sending AI service data when the first network element is the untrusted network element.

FIG. 7 illustrates a schematic flowchart of an AI service data transmission method provided by another embodiment of the present disclosure. This method can be applied to the system architecture introduced in FIG. 1 to FIG. 3 above. The method may include at least one of the following steps.

In this embodiment, the first network element is a trusted network element.
Step 710, second network element sends a terminal subscription information acquisition request to the Unified Data Management (UDM).

In some embodiments, the second network element is a NF. For example, the second network element is a NF on the core network side, i.e., the second network element may be referred to as a core network element.

In some embodiments, the terminal subscription information acquisition request includes the identification information of the terminal device.

In some embodiments, the identification information of the terminal device included in the terminal subscription information acquisition request is the internal identification information of the terminal device, where the internal identification information of the terminal device is identification information used by the terminal device inside the core network. For example, the internal identification information of the terminal device includes, but is not limited to, at least one of: SUPI, SUCI, or internal group ID.

In some embodiments, the terminal subscription information acquisition request further includes Access and Mobility Management Function (AMF) indication information. It should be noted that the AMF indication information is not an identification information of the AMF, and the AMF indication information indicates which type of network element UDM query. For example, the AMF indication information is the name of the AMF, which is used to inform the UDM that the query object is an AMF.

In some embodiments, the second network element invokes a fifth service to send the terminal subscription information acquisition request to the UDM, and the second network element uses the fifth service to implement step 710. For example, the fifth service may be referred to as Nudm_UECM_Get.
Step 720, the second network element receives a terminal subscription information acquisition response sent by the UDM.

In some embodiments, the terminal subscription information acquisition response includes identification information of the AMF. In some embodiments, the identification information of the AMF includes, but is not limited to, at least one of: ID of the AMF, address of the AMF, or URL of the AMF.
Step 730, the second network element sends a terminal location information acquisition request to the AMF based on the identification information of the AMF.

In some embodiments, the terminal location information acquisition request includes the identification information of the terminal device. In some embodiments, the identification information of the terminal device included in the terminal location information acquisition request is also internal identification information of the terminal device.

In some embodiments, the second network element invokes a sixth service to send the terminal location information acquisition request to the AMF using the sixth service, and the second network element uses the sixth service to implement step 730. For example, the sixth service may be referred to as Namf_Communication_UEContextTransfer.
Step 740, the second network element receives the terminal location information acquisition response sent by the AMF.

In some embodiments, the terminal location information acquisition response includes location information of the terminal device. In some embodiments, the second network element obtains the identification information of the first network element based on the location information of the terminal device. The location information of the terminal device is used to indicate where the terminal device is located, such as a certain area or a certain geographic location. For example, the location information of the terminal device includes, but is not limited to, at least one of: AoI, TAI, or cell identity.
Step 750, the second network element sends a first network element discovery request to the NRF.

In some embodiments, the first network element discovery request includes the location information of the terminal device.

In some embodiments, the first network element invokes a first service to send the first network element discovery request to the NRF using the first service, and the first network element uses the first service to implement step 750. For example, the first service may be referred to as Nnrf_NFDiscovery_Request.

In some embodiments, the first network element discovery request further includes first network element indication information. It should be noted that the first network element indication information is not the identification information of the first network element, and the first network element indication information indicates which type of network element the NRF discovers. For example, the first network element indication information is a name of the first network element, which is used to inform the NRF that discovery object is the first network element.

In some embodiments, after receiving the first network element discovery request, the NRF queries the locally stored registration information to find the identification information of the first network element that can cover the location information of the terminal device. The NRF is used to store the identification information of the first network element, a service area of the first network element, and a mapping relationship between the identification information of the first network element and the service area of the first network element. After querying the identification information of the first network element whose service area covers the location information of the terminal device, the NRF may send the first network element discovery response to the second network element.
Step 760, the second network element receives the first network element discovery response sent by the NRF.

In some embodiments, the first network element discovery response includes the identification information of the first network element, where the identification information of the first network element is information of the first network element that is obtained from the second registration information of the location information of the service area covering the terminal device. For example, the identification information of the first network element includes, but is not limited to, at least one of: ID of the first network element, address of the first network element, or URL of the first network element.

In some embodiments, the first network element discovery response further includes identification information of the terminal device. For example, the first network element discovery response includes the identification information of the first network element and the identification information of the terminal device.

In some embodiments, the NRF provides the identification information of the first network element serving the terminal device to the second network element, and the identification information of the first network element is used for the second network element to send the AI service data to the first network element, and the AI service data is sent by the first network element to the terminal device.
Step 770, the second network element sends the first message to the first network element based on the identification information of the first network element.

In some embodiments, the identification information of the first network element is used for the second network element to send the first message to the first network element. Accordingly, the first network element receives the first message sent by the second network element. In some embodiments, the first message includes the identification information of the terminal device and the AI service data.

In some embodiments, the second network element invokes a second service to send the first message to the first network element using the second service. The second network element uses the second service to implement step 770. For example, the second service may be referred to as Nnf_DataManagement_Notify.
Step 780, the first network element sends the AI service data to the terminal device based on the identification information of the terminal device.

In some embodiments, the identification information of the terminal device is used for the first network element to send the AI service data to the terminal device.

Accordingly, the terminal device receives the AI service data sent by the first network element serving the terminal device, and the AI service data is sent by the second network element to the first network element based on the identification information of the first network element.

In some embodiments, the first network element invokes a third service to send the AI service data to the terminal device using the third service. The first network element uses the third service to implement step 780. For example, the third service may be called Naf_DataManagement_Notify.

In some embodiments of the present disclosure, the names regarding the individual services (e.g., the first service, the second service, the third service, the fifth service, the sixth service, etc.) are only exemplary and explanatory, and different names may be set in practical applications, which are not limited by the present disclosure.

The present embodiment provides an implementation method for the second network element to obtain the identification information of the first network element based on the location information of the terminal device, and describes a process of sending AI service data in the case where the first network element is the trusted network element.

FIG. 8 illustrates a schematic flowchart of an AI service data transmission method provided by another embodiment of the present disclosure. The method may be applied in the system architecture presented in FIG. 1 to FIG. 3 above. The method may include at least one of the following steps (810 to 890).

In this embodiment, the first network element is an untrusted network element.
Step 810, second network element sends a terminal subscription information acquisition request to the UDM

In some embodiments, the second network element is a NF. For example, the second network element is a NF on the core network side, i.e., the second network element may be referred to as a core network element.

In some embodiments, the terminal subscription information acquisition request includes the identification information of the terminal device.

In some embodiments, the identification information of the terminal device included in the terminal subscription information acquisition request is the internal identification information of the terminal device, where the internal identification information of the terminal device is identification information used by the terminal device inside the core network. For example, the internal identification information of the terminal device includes, but is not limited to, at least one of: SUPI, SUCI, or internal group ID.

In some embodiments, the terminal subscription information acquisition request further includes Access and Mobility Management Function (AMF) indication information. It should be noted that the AMF indication information is not an identification information of the AMF, and the AMF indication information indicates which type of network element UDM query. For example, the AMF indication information is the name of the AMF, which is used to inform the UDM that the query object is an AMF.

In some embodiments, the second network element invokes a fifth service to send the terminal subscription information acquisition request to the UDM, and the second network element uses the fifth service to implement step 810. For example, the fifth service may be referred to as Nudm_UECM_Get.
Step 820, the second network element receives a terminal subscription information acquisition response sent by the UDM.

In some embodiments, the terminal subscription information acquisition response includes identification information of the AMF.
Step 830, the second network element sends a terminal location information acquisition request to the AMF based on the identification information of the AMF.

In some embodiments, the terminal location information acquisition request includes the identification information of the terminal device. In some embodiments, the identification information of the terminal device included in the terminal location information acquisition request is also the internal identification information of the terminal device.

In some embodiments, the second network element invokes a sixth service to send the terminal location information acquisition request to the AMF using the sixth service, and the second network element uses the sixth service to implement step 830. For example, the sixth service may be referred to as Namf_Communication_UEContextTransfer.
Step 840, the second network element receives the terminal location information acquisition response sent by the AMF.

In some embodiments, the terminal location information acquisition response includes the location information of the terminal device. In some embodiments, the second network element obtains the identification information of the first network element based on the location information of the terminal device. The location information of the terminal device is used to indicate where the terminal device is located, such as a certain area or a certain geographic location. For example, the location information of the terminal device includes, but is not limited to, at least one of: AoI, TAI, or cell identity.
Step 850, the second network element sends a first network element discovery request to the NRF.

In some embodiments, the first network element discovery request includes the location information of the terminal device.

In some embodiments, the first network element invokes a first service to send the first network element discovery request to the NRF using the first service, and the first network element uses the first service to implement step 850. For example, the first service may be referred to as Nnrf_NFDiscovery_Request.

In some embodiments, the first network element discovery request further includes first network element indication information. It should be noted that the first network element indication information is not the identification information of the first network element, and the first network element indication information indicates which type of network element the NRF discovers. For example, the first network element indication information is a name of the first network element, which is used to inform the NRF that discovery object is the first network element.

In some embodiments, after receiving the first network element discovery request, the NRF queries the locally stored registration information to find the identification information of the first network element that can cover the location information of the terminal device. The NRF is used to store the identification information of the first network element, a service area of the first network element, a mapping relationship between the identification information of the first network element and the service area of the first network element, and the identification information of the NEF serving the untrusted first network element. After querying the identification information of the first network element whose service area covers the location information of the terminal device, the NRF may send the first network element discovery response to the second network element.
Step 860, the second network element receives the first network element discovery response sent by the NRF.

In some embodiments, when the first network element is the untrusted network element, the first network element discovery response further includes the identification information of the NEF.

In some embodiments, the first network element discovery response includes the identification information of the first network element and the identification information of the NEF serving the untrusted first network element, where the identification information of the first network element is information of the first network element that is obtained from the second registration information of the location information of the service area covering the terminal device. For example, the identification information of the first network element includes, but is not limited to, at least one of: ID of the NEF, address of the NEF, or URL of the NEF.
Step 870, the second network element sends a second message to the NEF.

In some embodiments, the second network element sends the second message to the corresponding NEF based on the identification information of the NEF in the first network element discovery response. In some embodiments, the identification information of the NEF includes, but is not limited to, at least one of: ID of the NEF, address of the NEF, or URL of the NEF.

In some embodiments, the second message includes the identification information of the first network element, the identification information of the terminal device, and the AI service data.

In some embodiments, the identification information of the first network element is used for the second network element to send the second message to the NEF, and is used for the NEF to send the third message to the first network element.

Accordingly, the NEF sends the third message to the first network element based on the identification information of the first network element. The third message includes the identification information of the terminal device and the AI service data.

In some embodiments, the identification information of the terminal device included in the second message is the internal identification information of the terminal device, where the internal identification information of the terminal device is identification information used by the terminal device inside the core network. For example, the internal identification information of the terminal device includes, but is not limited to, at least one of: SUPI, SUCI, or internal group ID. Correspondingly, the NEF maps the internal identification information of the terminal device to the external identification information of the terminal device.

In some embodiments, the AI service data in the second message includes internal AI service data, the NEF is further used to map the internal AI service data to an external AI service data and send the external AI service data in the third message to the first network element. For example, the internal AI service data is the AI service data transmitted inside the core network, the external AI service data is the AI service data transmitted outside the core network. The internal AI service data and the external AI service data may be converted to each other, such as format conversion or other aspects of conversion. In some embodiments, NEF maps internal AI service data to external AI service data, and send the external AI service data in the third message to the first network element.
Step 880, the first network element receives the third message sent by the NEF.

In some embodiments, the third message includes the identification information of the terminal device and the AI service data.

In some embodiments, the identification information of the terminal device included in the third message is the external identification information of the terminal device, where the external identification information of the terminal device is identification information used by the terminal device outside of the core network. For example, the external identification information of the terminal device includes, but is not limited to, at least one of: GPSI, or external group ID.

In some embodiments, the NEF invokes a fourth service to send the third message to the first network element, and the NEF use the fourth service to implement step 640. For example, the fourth service may be referred to as Nnef_EventExposure_Notify or Nnef_AnalyticExposure_Notify.
Step 890, the first network element sends the AI service data to the terminal device based on the identification information of the terminal device.

In some embodiments, the identification information of the terminal device is used for the first network element to send the AI service data to the terminal device.

In some embodiments, the terminal device receives the AI service data sent by the first network element serving the terminal device, and the AI service data is sent by the second network element to the first network element based on the identification information of the first network element.

In some embodiments, the first network element invokes a third service to send the AI service data to the terminal device using the third service, and the first network element uses the third service to implement step 890. For example, the third service may be referred to as Naf_DataManagement_Notify.

In some embodiments of the present disclosure, the names regarding the individual services (e.g., the first service, the third service, the fourth service, the fifth service, the sixth service, etc.) are only exemplary and explanatory, and different names may be set in practical applications, which are not limited by the present disclosure.

This embodiment provides an implementation method for a second network element to obtain the identification information of the first network element based on the identification information of the terminal device, and describes a process of sending AI service data in the case where the first network element is the untrusted network element.

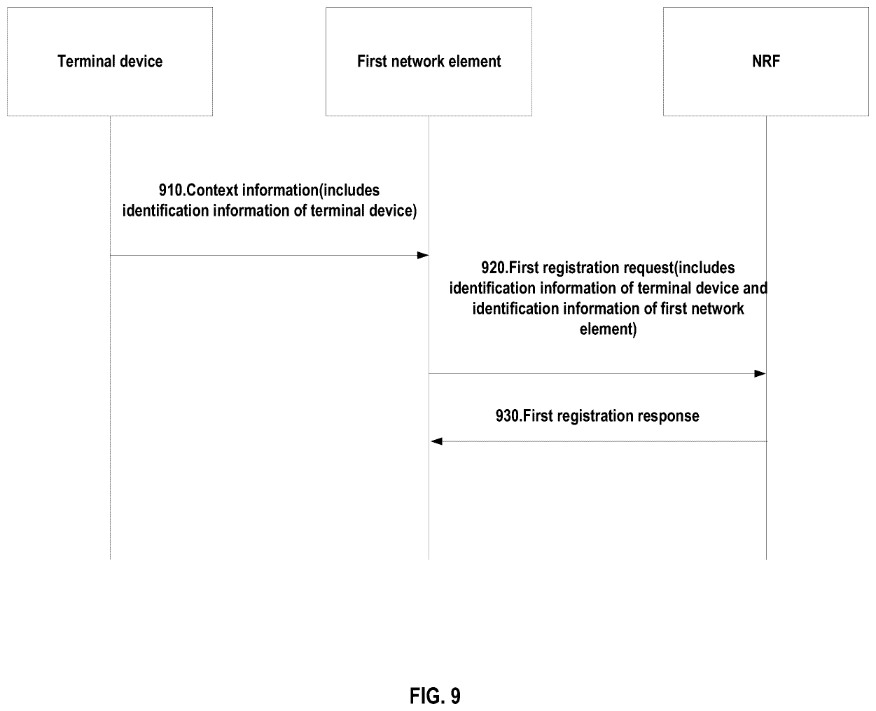

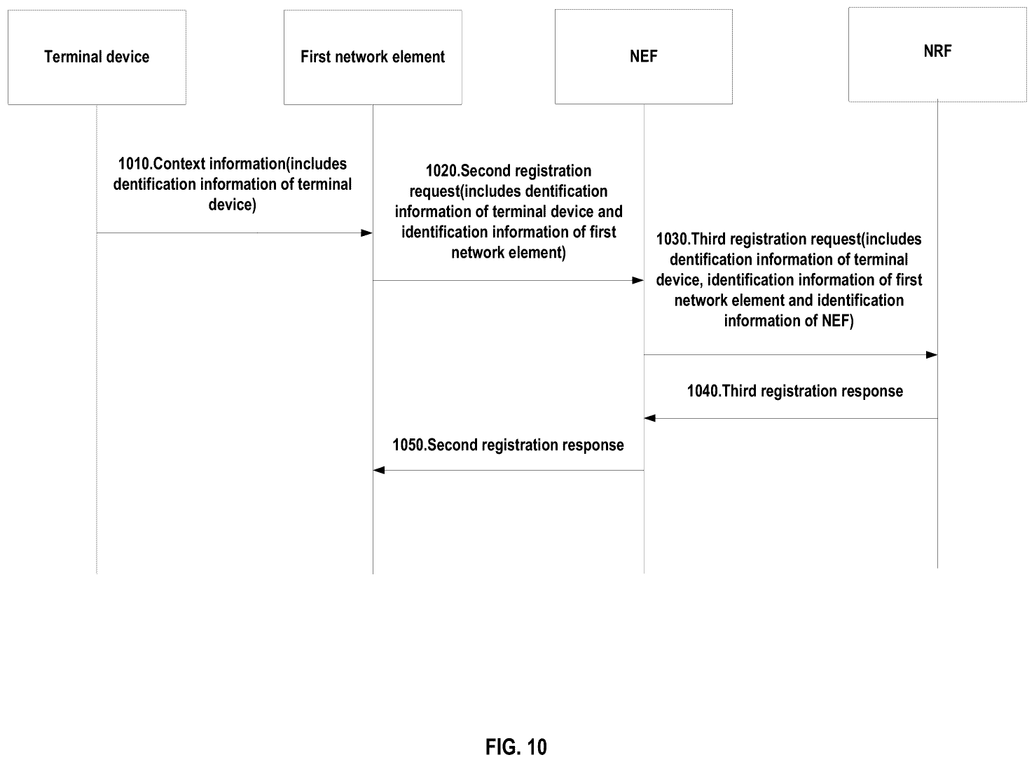

The registration process of the first network element is described below through several embodiments. For details not described in detail in the embodiment shown in FIG. 9 and FIG. 10, reference may be made to the introductory description in other embodiments in the context.

FIG. 9 illustrates a schematic flowchart of an AI service data transmission method provided by another embodiment of the present disclosure. The method may be applied in the system architecture presented in FIG. 1 to FIG. 3 above. The method may include at least one of the following steps (910 to 930).

In this embodiment, the first network element is a trusted network element.
Step 910, terminal device sends a context information of the terminal device to first network element.

In some embodiments, the context information includes an identification information of the terminal device.
Step 920, the first network element sends a first registration request to the NRF.

In some embodiments, the first registration request includes the identification information of the terminal device and an identification information of the first network element. In some embodiments, the identification information of the terminal device is stored and a mapping relationship with the identification information of the first network element is established by the NRF. In some embodiments, the identification information of the first network element includes an ID of the first network element and an address of the first network element. For example, the ID of the first network element is a unique identifier of the first network element. For example, the address of the first network element is the Fully Qualified Domain Name (FQDN) or Internet Protocol (IP) address of the first network element.

In some embodiments, the first registration request also includes a service area, and it should be noted that the service area is a service area of the first network element. Accordingly, only terminal device located within the service area can be served by the first network element. For example, the service area of the first network element is one or more AoIs. For example, the service area of the first network element is one or more TAIs. For example, the service area of the first network element is one or more cell identity.

In some embodiments, the identification information of the terminal device included in the first registration request is an internal identification information of the terminal device, where the internal identification information of the terminal device is identification information used by the terminal device inside the core network. For example, the internal identification information of the terminal device includes, but is not limited to, at least one of: SUPI, SUCI, or internal group ID.

In some embodiments, the identification information of the terminal device included in the first registration request is an external identification information of the terminal device, where the external identification information of the terminal device is identification information used by the terminal device outside of the core network. For example, the external identification information of the terminal device includes, but is not limited to, at least one of: GPSI, or external group ID.

In some embodiments, the first network element invokes a seventh service to send the first registration request to the NRF, and the first network element uses the seventh service to implement step 920. For example, the seventh service may be referred to as Nnrf_NFManagement_NFRegister or Nnrf_NFManagement_NFUpdate.

In some embodiments, after the first network element successfully registers in the NRF, the identification information of the terminal device is stored and a mapping relationship with the identification information of the first network element is established by the NRF. The NRF receives the first registration request sent by the first network element, stores the identification information of the terminal device, establishes a mapping relationship between the identification information of the terminal device and the identification information of the first network element, and establishes a mapping relationship between the service area of the first network element and the identification information of the first network element.
Step 930, The NRF sends a first registration response to the first network element.

In some embodiments, the first network element receives the first registration response sent by the NRF, and the first registration response is used to indicate that the registration process of the first network element has been completed.

In some embodiments of the present disclosure, the names regarding the individual services (e.g., the seventh service, etc.) are only exemplary and explanatory, and different names may be set in practical applications, which are not limited by the present disclosure.

This embodiment provides a technical solution that provides a registration method of a trusted first network element, such that a mapping can be formed between the identification information of the terminal device and the identification information of the first network element, as well as a mapping between the identification information of the first network element and the service area of the first network element. It is convenient to subsequently find the first network element serving the terminal device, and send the AI service data from the core network element to the terminal device through the first network element.

FIG. 10 illustrates a schematic flowchart of an AI service data transmission method provided by another embodiment of the present disclosure. The method may be applied in the system architecture presented in FIG. 1 to FIG. 3 above. The method may include at least one of the following steps (1010 to 1050).

In this embodiment, the first network element is an untrusted network element.
Step 1010, terminal device sends a context information of the terminal device to first network element.

In some embodiments, the context information includes an identification information of the terminal device.
Step 1020, the first network element sends a second registration request to the NRF.

In some embodiments, the second registration request includes the identification information of the terminal device and an identification information of the first network element.

In some embodiments, the identification information of the terminal device included in the second registration request is an external identification information of the terminal device, where the external identification information of the terminal device is identification information used by the terminal device outside of the core network. In some embodiments, the identification information used by the terminal device outside the core network is used for the NEF to map to the identification information used by the terminal device inside the core network. For example, the external identification information of the terminal device includes, but is not limited to, at least one of: GPSI, or external group ID.

In some embodiments, the identification information of the first network element includes an ID of the first network element and an address of the first network element. For example, the ID of the first network element is a unique identifier of the first network element. For example, the address of the first network element is the FQDN or IP address of the first network element.

In some embodiments, the second registration request further includes at least one of: external service area of the first network element, address of the first network element, or first indication information. Accordingly, the external service area of the first network element is a service area of the first network element. For example, the external service area of the first network element includes, but is not limited to, at least one of: Global Positioning System (GPS) coordinates, or city street address. Accordingly, only the terminal device located within the service area can be served by the first network element. The first indication information is used to indicate NEF that the second registration request is a registration request message sent to the NRF. Accordingly, the NEF determines through the first indication information that the received second registration request is the registration request information sent by the first network element to the NRF.

In some embodiments, the first network element invokes an eighth service to send the second registration request to the NEF, and the first network element uses the eighth service to implement step 1020. For example, the seventh service may be referred to as Nnef_EventExposure_Subscribe.
Step 1030, NEF sends a third registration request to NRF.

In some embodiments, the second registration request is used to trigger the NEF to send a third registration request to the NRF. The third registration request includes the identification information of the terminal device, the identification information of the first network element, and an identification information of the NEF serving the first network element. The identification information of the terminal device is used to be stored and establish a mapping relationship between the identification information of the first network element and the identification information of the NEF by the NRF.

In some embodiments, the identification information of the terminal device included in the third registration request is identification information used by the terminal device inside the core network.

In some embodiments, the NEF is further used to map the identification information used by the terminal device outside the core network to the identification information used by the terminal device inside the core network. In some embodiments, the NEF is further used to map an external service area of the first network element to an internal service area of the first network element. In some embodiments, the NEF also stores the registration information of the first network element in the NEF or a Unified Data Repository (UDR).

In some embodiments, the third registration request further includes at least one of: internal service area of the first network element, address of the first network element, or address of the NEF. For example, the identification information of the NEF is the unique identifier of NEF, which is used to identify the NEF serving the untrusted first network element. For example, the address of the NEF is the FQDN or IP address of the NEF.
Step 1040, the NRF sends a third registration response to the NEF.

In some embodiments, the NRF establishes a mapping relationship between the internal identification information of the terminal device and the identification information of the first network element.

For example, the NRF stores the messages in the second network element registration request.

In some embodiments, the NRF stores the identification information of the terminal device, the identification information of the first network element, the identification information of the NEF.

Accordingly, the NEF receives the third registration response sent by the NRF, and the third registration response is used to indicate that the mapping process of the identification information of the terminal device and the identification information of the first network element has been completed.

In some embodiments, the NRF invokes a seventh service to send the third registration request to the NEF, and the NRF uses the seventh service to implement step 1040. For example, the seventh service may be referred to as Nnrf_NFManagement_NFRegister or Nnrf_NFManagement_NFUpdate.

For example, after receiving a registration request sent by NEF, NRF determines the registration information of the first network element in NRF, and sends the third registration response to NEF. For example, after receiving the registration request sent by NEF, NRF updates the registration information of the first network element in NRF and sends a third registration response to NEF.
Step 1050, the NEF sends a second registration response to the first network element.

The first network element receives the second registration response sent by the NEF, and the second registration response is used to indicate that the registration process of the first network element has been completed.

In some embodiments of the present disclosure, the names regarding the individual services (e.g., the seventh service, the eighth service, etc.) are only exemplary and explanatory, and different names may be set in practical applications, which are not limited by the present disclosure.

The technical solution provided by embodiments of the present disclosure provides an untrusted first network element registration method. A mapping relationship is established between identification information of the terminal device and the identification information of the first network element, and a mapping relationship is established between the identification information of the first network element and a service area of the first network element, so as to facilitate the first network element to find a target terminal device through the identification information of the terminal device and send the AI service data sent by the core network element to the terminal device. The core network element may send the AI service data includes AI or ML models, analysis result, metadata, intermediate results of model training, and raw data to implement functions such as federated learning and enrich the application scenarios of AI services.

It should be noted that in the above embodiments, the technical solutions of the present disclosure are introduced and illustrated only from the perspective of the interaction of a plurality of devices (or network elements) for ease of understanding. The above steps related to the execution of the first network element can be independently implemented as a transmission method of AI service data on the first network element side. The above steps related to the execution of the second network element can be independently implemented as a transmission method of AI service data on the second network element side. The above steps related to the execution of the terminal device can be independently implemented as a transmission method of AI service data on the terminal device side. The above steps related to UEF execution can be implemented independently as a transmission method of AI service data on the UEF side. The above steps related to NRF execution can be implemented independently as a transmission method of AI service data on the NRF side. The above steps related to UDM execution can be implemented separately as the transmission method of AI service data on the UDM side. The above-mentioned steps related to AMF execution can be implemented independently as a transmission method of AI service data on the AMF side.

The following is an example of the apparatus embodiment of the present disclosure, which can be used to perform the method embodiment of the present disclosure. For details not disclosed in the apparatus embodiments of the present disclosure, please refer to the method embodiments of the present disclosure.

FIG. 11 is a schematic block diagram of apparatus for AI service data transmission according to an embodiment of the present disclosure. The apparatus can be implemented as a terminal device, or can be implemented as a part of the terminal device. As illustrated in FIG. 11, the apparatus 1100 includes a receiver module 1110.

The receiver module 1110 is configured to receive AI service data sent by the first network element serving the terminal device. The AI service data is sent by the second network element to the first network element based on the identification information of the first network element.

In some embodiment, the first network element is a trusted network element.

In some embodiments, the identification information of the first network element is used for the second network element to send the first message to the first network element. The first message includes an identification information of the terminal device and the AI service data.

In some embodiments, the first network element is an untrusted network element.

In some embodiments, the identification information of the first network element is used for the second network element to send a second message to the NEF, and is used for the NEF to send a third message to the first network element, where the second message includes the identification information of the first network element, the identification information of the terminal device and the AI service data, and the third message includes the identification information of the terminal device and the AI service data.

In some embodiments, the AI service data in the second message includes internal AI service data, the NEF maps the internal AI service data to an external AI service data and sends the external AI service data in a third message to the first network element.

In some embodiments, the apparatus 1100 further includes a sender module 1120.

The sender module 1120 is configured to send context information of the terminal device to the first network element, where the context information includes the identification information of the terminal device.

After the first network element successfully registers in the NRF, the identification information of the terminal device is used to be stored and establish a mapping relationship with the identification information of the first network element by the NRF.

In some embodiments, the identification information of the first network element includes at least one of: ID of the first network element, address of the first network element, or URL of the first network element.

In some embodiments, the AI service data includes at least one of: AI or ML models, analysis result, metadata, intermediate results of model training, or raw data.

In some embodiments, the second network element is a core network element.

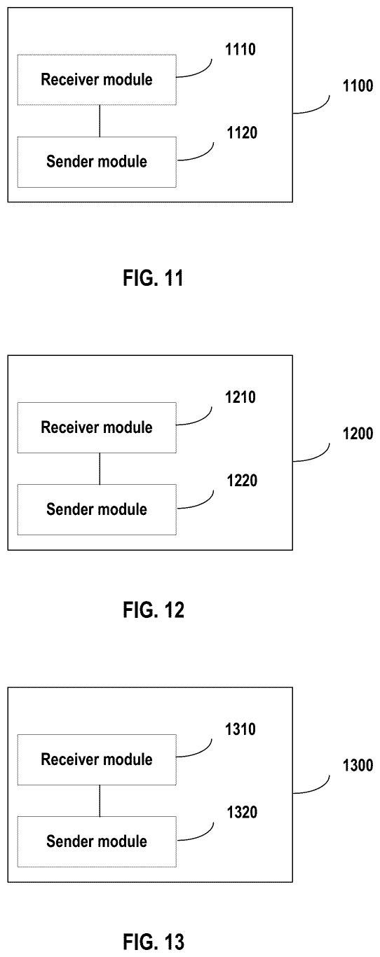

FIG. 12 is a schematic block diagram of apparatus for AI service data transmission according to an embodiment of the present disclosure. The apparatus can be implemented as a first network element, or can be implemented as a part of the first network element. As illustrated in FIG. 12, the apparatus 1200 includes a receiver module 1210 and a sender module 1220.

The receiver module 1210 is configured to obtain the AI service data and the identification information of the terminal device from the second network element;

The sender module 1120 is configured to send the AI service data to the terminal device based on an identification information of the terminal device.

In some embodiment, the first network element is a trusted network element.

In some embodiments, the receiver module 1210 is configured to receive the first message sent by the second network element, where the first message includes the identification information of the terminal device and the AI service data.

In some embodiments, the receiver module 1210 is configured to obtain context information from the terminal device, where the context information includes the identification information of the terminal device.

The sender module 1220 is configured to send a first registration request to the NRF, where the first registration request includes the identification information of the terminal device and the identification information of the first network element;

Where, the identification information of the terminal device is used to be stored and establish a mapping relationship with the identification information of the first network element by the NRF.

In some embodiments, the identification information of the terminal device included in the first registration request is the identification information used by the terminal device inside the core network.

In some embodiments, the first registration request further includes at least one of: service area of the first network element, or address of the first network element.

In some embodiments, the first network element is an untrusted network element.

In some embodiments, the receiver module 1210 is configured to receive a third message sent by NEF, where the third message includes the identification information of the terminal device and the AI service data.

The AI service data is sent by the second network element to the NEF through a second message, where the second message includes the identification information of the first network element, the identification information of the terminal device and the AI service data.

In some embodiments, the AI service data in the second message includes internal AI service data, the NEF maps the internal AI service data to an external AI service data and sends the external AI service data in the third message to the first network element.

In some embodiments, the receiver module 1210 is configured to obtain context information from the terminal device, where the context information includes identification information of the terminal device.

The sender module 1220 is configured to send a second registration request to the NEF, where the second registration request includes the identification information of the terminal device and the identification information of the first network element.

The second registration request is used to trigger the NEF to send a third registration request to the NRF. The third registration request includes the identification information of the terminal device, the identification information of the first network element and the identification information of the NEF. The identification information of the terminal device is used to be stored and establish a mapping relationship with the identification information of the first network element by the NRF.

In some embodiments, the identification information of the terminal device included in the second registration request is the identification information used by the terminal device outside the core network.

The identification information of the terminal device included in the third registration request is the identification information used by the terminal device inside the core network.

The identification information used by the terminal device outside the core network is used for the NEF to map to the identification information used by the terminal device inside the core network.

In some embodiments, the second registration request further includes at least one of: external service area of the first network element, address of the first network element, or first indication information. The first indication information is used to indicate the first network element to register with the NRF.

The third registration request also includes at least one of: internal service area of the first network element, address of the first network element, or address of the NEF.

In some embodiments, the AI service data includes at least one of: AI or ML models, analysis result, metadata, intermediate results of model training, or raw data.

In some embodiments, the second network element is a core network element.

FIG. 13 is a schematic block diagram of apparatus for AI service data transmission according to an embodiment of the present disclosure. The apparatus can be implemented as a second network element, or can be implemented as a part of the second network element. As illustrated in FIG. 13, the apparatus 1300 includes a receiver module 1310 and a sender module 1320.

The receiver module 1310 is configured to obtain the identification information of the first network element serving the terminal device.

The sender module 1320 is configured to send AI service data to the first network element based on the identification information of the first network element, where the AI service data is sent by the first network element to the terminal device.

In some embodiment, the first network element is a trusted network element.

In some embodiments, the sender module 1320 is configured to send a first message to the first network element based on the identification information of the first network element, where the first message includes an identification information of the terminal device and the AI service data.

In some embodiments, the first network element is an untrusted network element.

In some embodiments, the sender module 1320 is configured to send a second message to the NEF, where the second message includes the identification information of the first network element, the identification information of the terminal device and the AI service data.

The identification information of the first network element is used for the NEF to send a third message to the first network element, where the third message includes the identification information of the terminal device and the AI service data.

In some embodiments, the AI service data in the second message includes internal AI service data, the NEF maps the internal AI service data to an external AI service data and sends the external AI service data in the third message to the first network element.

In some embodiments, the identification information of the first network element is obtained based on the identification information of the terminal device.

In some embodiments, the sender module 1320 is configured to send a first network element discovery request to the NRF, where the first network element discovery request includes the identification information of the terminal device.

The receiver module 1310 is configured to receive a first network element discovery response sent by the NRF, where the first network element discovery response includes the identification information of the first network element. The identification information of the first network element is the information of the first network element that has a mapping relationship with the identification information of the terminal device obtained from the first registration information.

In some embodiments, the identification information of the terminal device included in the first network element discovery request is the identification information used by the terminal device inside the core network.

In some embodiments, the identification information of the first network element is obtained based on the location information of the terminal device.

In some embodiments, the sender module 1320 is configured to send a first network element discovery request to the NRF, where the first network element discovery request includes the location information of the terminal device.

The receiver module 1310 is configured to receive a first network element discovery response sent by the NRF, where the first network element discovery response includes the identification information of the first network element. The identification information of the first network element is the information of the first network element whose service area obtained from the second registration information covers the location information of the terminal device.

In some embodiments, the sender module 1320 is configured to send a terminal subscription information acquisition request to UDM, where the terminal subscription information acquisition request includes the identification information of the terminal device.

The receiver module 1310 is configured to receive a terminal subscription information acquisition response sent by the UDM, where the terminal subscription information acquisition response includes identification information of AMF.

The sender module 1320 is configured to send a terminal location information acquisition request to the AMF based on the identification information of the AMF, where the terminal location information acquisition request includes the identification information of the terminal device.

The receiver module 1310 is configured to receive a terminal location information acquisition response sent by the AMF, where the terminal location information acquisition response includes the location information of the terminal device.

In some embodiments, the identification information of the terminal device included in the terminal subscription information acquisition request and the terminal location information acquisition request is the identification information used by the terminal device inside the core network.

In some embodiments, the location information includes at least one of: AoI, TAI, or cell identity.

In some embodiments, when the first network element is an untrusted network element, the first network element discovery response further includes an identification information of the NEF.

In some embodiments, the identification information of the first network element includes at least one of: ID of the first network element, address of the first network element, or URL of the first network element.

In some embodiments, the AI service data includes at least one of: AI or ML models, analysis result, metadata, intermediate results of model training, or raw data.

In some embodiments, the second network element is a core network element.

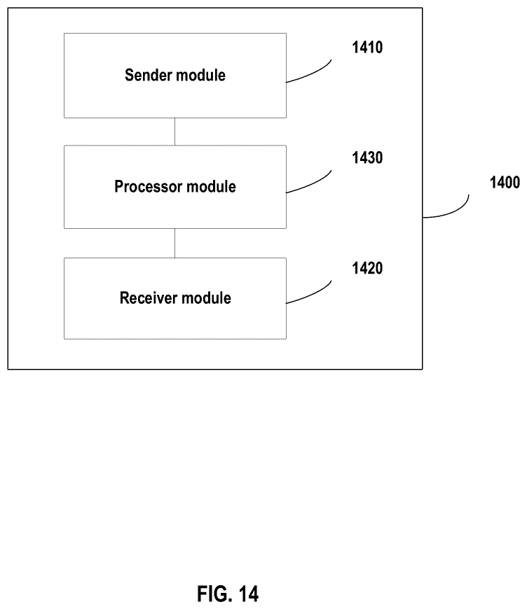

FIG. 14 is a schematic block diagram of apparatus for AI service data transmission according to an embodiment of the present disclosure. The apparatus can be implemented as a NRF, or can be implemented as a part of the NRF. As illustrated in FIG. 14, the apparatus 1400 includes a sender module 1410.

The sender module 1410 is configured to provide the identification information of the first network element serving the terminal device to the second network element. The identification information of the first network element is used for the second network element to send AI service data to the first network element, and the AI service data is sent by the first network element to the terminal device.

In some embodiments, the apparatus 1400 further includes:

A receiver module 1420, where the receiver module 1420 is configured to receive a first network element discovery request from the second network element, where the first network element discovery request includes an identification information of the terminal device.

A processor module 1430, where the processor module 1430 is configured to obtain the identification information of the first network element that has a mapping relationship with the identification information of the terminal device from the first registration information.

The sender module 1410 is configured to send a first network element discovery response to the second network element, where the first network element discovery response includes the identification information of the first network element.

In some embodiments, the identification information of the terminal device included in the first network element discovery request is the identification information used by the terminal device inside the core network.

In some embodiments, the apparatus 1400 further includes:

The receiver module 1420 is configured to receive a first network element discovery request from the second network element, where the first network element discovery request includes the location information of the terminal device.

The processor module 1430 is configured to obtain the identification information of the first network element whose service area covers the location information of the terminal device from the second registration information.

The sending module 1410 is configured to send a first network element discovery response to the second network element, where the first network element discovery response includes the identification information of the first network element.

In some embodiments, the location information includes at least one of the following: AoI, TAI, or cell identity.

In some embodiments, when the first network element is an untrusted network element, the first network element discovery response further includes identification information of the NEF.

In some embodiments, the first network element is a trusted network element, and the apparatus 1400 further includes:

The receiver module 1420 is configured to receive a first registration request from the first network element, where the first registration request includes the identification information of the terminal device and the identification information of the first network element.

The processor module 1430 is configured to store the identification information of the terminal device, the identification information of the first network element, and the mapping relationship between the identification information of the terminal device and the identification information of the first network element.

In some embodiments, the identification information of the terminal device included in the first registration request is the identification information used by the terminal device inside the core network.

In some embodiments, the first registration request further includes at least one of: service area of the first network element, or address of the first network element.

In some embodiments, the first network element is an untrusted network element, and the apparatus 1400 further includes:

The receiver module 1420 is configured to receive a third registration request from NEF, where the third registration request includes the identification information of the terminal device, the identification information of the first network element, and the identification information of the NEF. The third registration request is sent by the NEF after receiving a second registration request from the first network element, and the second registration request includes the identification information of the terminal device and the identification information of the first network element.

The processor module 1430 is configured to store the identification information of the terminal device, the identification information of the first network element, the identification information of the NEF, and a mapping relationship between the identification information of the terminal device, the identification information of the first network element and the identification information of the NEF.

In some embodiments, the identification information of the terminal device included in the second registration request is the identification information used by the terminal device outside the core network.

The identification information of the terminal device included in the third registration request is the identification information used by the terminal device inside the core network.

The identification information used by the terminal device outside the core network is used for the NEF to map to the identification information used by the terminal device inside the core network.

In some embodiments, the second registration request further includes at least one of: external service area of the first network element, address of the first network element, or first indication information. The indication information is used to indicate the first network element to register with the NRF.

The third registration request also includes at least one of: internal service area of the first network element, address of the first network element, or address of the NEF.

In some embodiments, the identification information of the first network element includes at least one of: ID of the first network element, address of the first network element, or URL of the first network element.

In some embodiments, the AI service data includes at least one of: AI or ML models, analysis result, metadata, intermediate results of model training, or raw data

In some embodiments, the second network element is a core network element.

It should be noted that when the apparatus provided in the above embodiment implements its functions, only the division of the above functional modules is used as an example. In practical applications, the above functions can be allocated to different functional modules according to actual needs. That is, the content structure of the apparatus is divided into different functional modules to complete all or part of the functions described above.

Regarding the apparatus in the above embodiments, the specific manner in which each module performs operations has been described in detail in the embodiments related to the method, and will not be described in detail here.

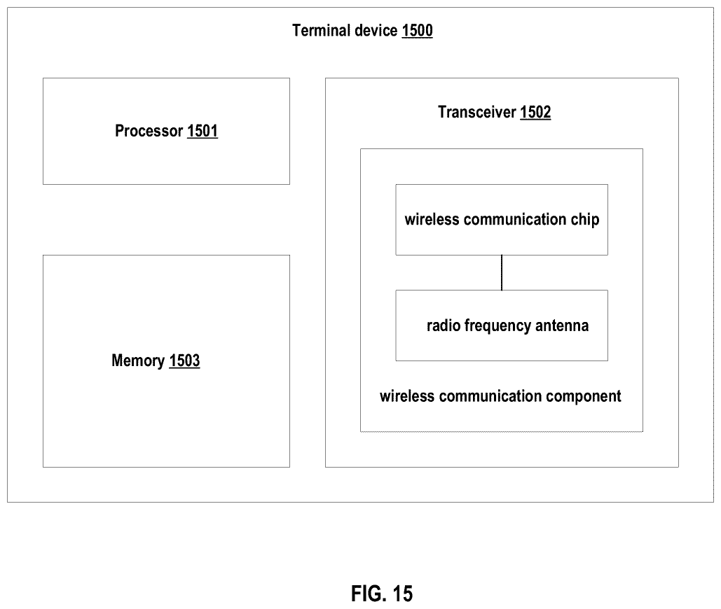

FIG. 15 is a schematic structural diagram of terminal device according to an embodiment of the present disclosure. The terminal device 1500 can include a processor 1501, a transceiver 1502, and a memory 1503.

The processor 1501 includes one or more processing cores. The processor 1501 executes various functional applications and information processing by running software programs and modules.

The transceiver 1502 may include a receiver and a transmitter. For example, the receiver and the transmitter may be implemented as the same wireless communication component, and the wireless communication component may include a wireless communication chip and a radio frequency antenna.

The memory 1503 may be connected to processor 1501 and transceiver 1502.

The memory 1503 can be used to store a computer program executed by the processor, and the processor 1501 is used to execute the computer program to implement various steps executed by the terminal device in the above method embodiment.

Additionally, the memory 1503 may be implemented by any type of transitory or non-transitory storage device, or combination thereof. Transitory or non-transitory storage device includes but not limited to: magnetic or optical disks, electrically erasable programmable read-only memory, erasable programmable read-only memory, static ready-access memory, read-only memory, magnetic memory, flash memory, programmable read-only memory.

In an embodiment, the transceiver 1502 is configured to receive AI service data sent by a first network element serving the terminal device. The AI service data is sent by a second network element to the first network element based on the identification information of the first network element.

For details that are not described in detail in this embodiment, please refer to the above embodiments and will not be described again here.

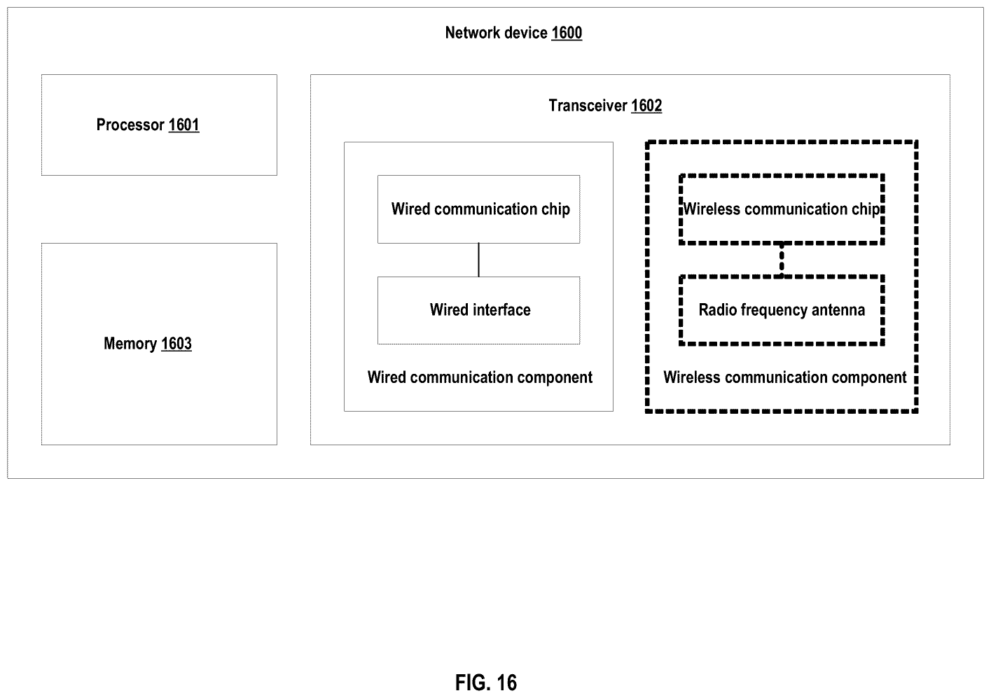

FIG. 16 is a schematic structural diagram of network device according to an embodiment of the present disclosure. The network device 1600 can include a processor 1601, a transceiver 1602, and a memory 1603.

The processor 1601 includes one or more processing cores. The processor 1601 executes various functional applications and information processing by running software programs and modules.

The transceiver 1602 may include a receiver and a transmitter. For example, the transceiver 1602 may include a wired communication component, and the wired communication component may include a wired communication chip and a wired interface (such as an optical fiber interface). In some embodiments, the transceiver 1602 may also include a wireless communication component, which may include a wireless communication chip and a radio frequency antenna.

The memory 1603 may be connected to processor 1601 and transceiver 1602.

The memory 1603 may be used to store a computer program executed by the processor, and the processor 1601 is used to execute the computer program to implement various steps performed by the first network element or the second network element in the above method embodiment.

Additionally, the memory 1603 may be implemented by any type of transitory or non-transitory storage device, or combination thereof. Transitory or non-transitory storage device includes but not limited to: magnetic or optical disks, electrically erasable programmable read-only memory, erasable programmable read-only memory, static ready-access memory, read-only memory, magnetic memory, flash memory, programmable read-only memory.

In an embodiment, when the network device is the first network element, the transceiver 1602 is used to obtain the AI service data from the second network element and the identification information of the terminal device. The transceiver 1602 sends the AI service data to the terminal device based on the identification information of the terminal device.

In an embodiment, when the network device is the second network element, the transceiver 1602 is used to obtain the identification information of the first network element serving the terminal device. The transceiver 1602 sends the AI service data to the first network element based on the identification information of the first network element, and the AI service data is sent by the first network element to the terminal device.

In an embodiment, when the network device is an NRF, the transceiver 1602 is configured to provide the second network element with the identification information of the first network element serving the terminal device. The identification information of the first network element is used for the second network element to send AI service data to the first network element, and the AI service data is sent by the first network element to the terminal device.

For details that are not described in detail in this embodiment, please refer to the above embodiments and will not be described again here.

A computer-readable storage medium is provided in embodiments of the present disclosure. A computer program is stored in the computer-readable storage medium, and the computer program is loaded and executed by the processor to perform the AI service data transmission method performed by the communication device (such as a terminal device, or a first network element, or a second network element, or a NRF) provided by the above method embodiment. In some embodiments, the computer-readable storage medium may include: Read-Only Memory (ROM), Random-Access Memory (RAM), Solid State Drives (SSD), or optical disks, etc. Among them, the random access memory may include Resistance Random Access Memory (ReRAM) and Dynamic Random Access Memory (DRAM).

A chip is provided in embodiments of the present disclosure. The chip includes programmable logic circuits and/or program instructions. When the chip is run on a communication device, it is used to perform the communication provided by the above method embodiment. A method of transmitting AI service data executed by a device (such as a terminal device, or a first network element, or a second network element, or an NRF).

A computer program product is provided in embodiments of the present disclosure. When the computer program product is run on the processor of the communication device, the computer program product executes the AI service data transmission method performed by the communication device (Such as terminal equipment, or the first network element, or the second network element, or NRF) provided by the above method embodiment.

It should be understood that the “indication” mentioned in some embodiments of the present disclosure may be a direct indication, an indirect indication, or an association relationship. For example, A indicates B, which can mean that A directly indicates B, for example, B can be obtained through A. A indicates B, which can also mean that A indirectly indicates B, for example, A indicates C, and B can be obtained through C. A indicates B, which can also mean that there is an association relationship between A and B.

In the description of the embodiments of the present disclosure, the term “correspondence” can mean that there is a direct correspondence or indirect correspondence between the two, or an associated relationship between the two, or a relationship between instructing and being instructed, or configuring and being configured, and the like.

The “plurality” mentioned in the present disclosure means two or more than two. “And/or” describes the relationship between associated objects, indicating that there can be three relationships. For example, A and/or B can mean: A exists alone, A and B exist simultaneously, and B exists alone. The character “/” generally indicates that the related objects are in an “or” relationship.

“Greater than or equal to” mentioned herein may mean equal to or greater than, and “less than or equal to” may mean equal to or less than.

In addition, the step numbers described in this article only illustrate a execution sequence between the steps. In some other embodiments, the above steps may not be executed in the numbering sequence, such as two different numbers. The steps are executed simultaneously, or two steps with different numbers are executed in the reverse order as shown in the figure, which is not limited in some embodiments of the present disclosure.

A person of ordinary skill in the art can understand that in one or more of the above examples, the functions described in some embodiments of the present application can be implemented using hardware, software, firmware, or any combination thereof. When implemented using software, the functions may be stored on or transmitted over as one or more instructions or code on a computer-readable medium. Computer-readable media includes computer storage media and communication media includes any medium that facilitates transfer of a computer program from one place to another. Storage media can be any available media that can be accessed by a general purpose or special purpose computer.

The above are only embodiments of the present disclosure and are not intended to limit the present disclosure. Any modifications, equivalent substitutions, improvements, etc. made within the spirit and principles of the present disclosure shall be included in the scope of protection of the present disclosure.

What is claimed is:

1. A terminal device, comprising:
a transceiver;
a memory configured to store executable instructions; and
a processor configured to execute the executable instructions stored in the memory to cause the transceiver to:
receive Artificial Intelligence (AI) service data sent by a first network element serving the terminal device, wherein the AI service data is sent by a second network element to the first network element based on first identification information of the first network element.

2. The terminal device according to claim 1, wherein the first network element is a trusted network element, or an untrusted network element.

3. The terminal device according to claim 2, wherein the first identification information of the first network element is used for the second network element to send a first message to the first network element, and the first message comprises second identification information of the terminal device and the AI service data, or
wherein the identification information of first network element is used by the second network element to send the second message to a Network Exposure Function (NEF), and is used by the NEF to send a third message to the first network element, wherein the second message includes the identification information of first network element, the second identification information of terminal device and the AI service data, and the third message includes the second identification information of terminal device and the AI service data.

4. The terminal device according to claim 3, wherein the AI service data in the second message comprises an internal AI service data, and the internal AI service data is used for the NEF to map to an external AI service data, and to send the external AI service data in the third message to the first network element.

5. The terminal device according to claim 1, the processor configured to cause the transceiver to:
send a context information of the terminal device to the first network element, wherein the context information comprises second identification information of the terminal device,
wherein after the first network element successfully registers in a Network Repository Function (NRF), the second identification information of the terminal device is used to be stored and establish a mapping relationship with the first identification information of the first network element by the NRF.

6. The terminal device according to claim 1, wherein the first identification information of the first network element comprises at least one of: an Identification (ID) of the first network element, an address of the first network element, or an Uniform Resource Locator (URL) of the first network element, and
wherein the AI service data comprises at least one of: an AI or machine learning ML model, an analysis result, metadata, intermediate results of model training, or raw data.

7. A first network element, comprising:
a transceiver;
a memory configured to store executable instructions; and
a processor configured to execute the executable instructions stored in the memory to cause the transceiver to:
obtain an Artificial Intelligence (AI) service data and second identification information of a terminal device from a second network element; and
send the AI service data to the terminal device based on the second identification information of the terminal device.

8. The first network element according to claim 7, wherein the first network element is a trusted network element, or the first network element is an untrusted network element.

9. The first network element according to claim 8, the processor configured to cause the transceiver to:
receive a first message sent by the second network element, wherein the first message comprises the second identification information of the terminal device and the AI service data.

10. The first network element according to claim 8, the processor configured to cause the transceiver to:
obtain context information from the terminal device, wherein the context information comprises the second identification information of the terminal device; and
send a first registration request to a Network Repository Function (NRF),
wherein the first registration request comprises the second identification information of the terminal device and first identification information of the first network element, and
wherein the second identification information of the terminal device is used to establish a mapping relationship with the first identification information of the first network element by the NRF.

11. The first network element according to claim 8, the processor configured to cause the transceiver to:
receive a third message sent by a Network Exposure Function (NEF),
wherein the third message comprises the second identification information of the terminal device and the AI service data,
wherein the AI service data is sent by the second network element to the NEF via the second message, and
wherein the second message comprises first identification information of the first network element, the second identification information of the terminal device, and the AI service data.

12. The first network element according to claim 11,
wherein the AI service data in the second message comprises an internal AI service data,
wherein the internal AI service data is used for the NEF to map to an external AI service data, and
wherein the external AI service data in the third message is sent to the first network element.

13. The first network element according to claim 8, the processor configured to cause the transceiver to:
obtain context information from the terminal device, wherein the context information comprises the second identification information of the terminal device; and
send a second registration request to a Network Exposure Function (NEF),
wherein the second registration request comprises the second identification information of the terminal device and first identification information of the first network element,
wherein the second registration request is used to trigger the NEF to send a third registration request to a Network Repository Function (NRF), and the third registration request comprises the second identification information of the terminal device, the first identification information of the first network element, and third identification information of the NEF, and
wherein the second identification information of the terminal device is used to establish a mapping relationship between the first identification information of the first network element and the third identification information of the NEF by the NRF.

14. The first network element according to claim 13,
wherein the second identification information of the terminal device included in the second registration request is the identification information used by the terminal device outside a core network,
wherein the second identification information of the terminal device included in the third registration request is the identification information used by the terminal device inside the core network, and
wherein the identification information used by the terminal device outside the core network is used for the NEF to map to the identification information used by the terminal device inside the core network.

15. The first network element according to claim 13,
wherein the first registration request further includes at least one of: a service area of the first network element, or an address of the first network element,
wherein the second registration request further comprises at least one of: an external service area of the first network element, an address of the first network element, or a first indication information, wherein the first indication information is used to indicate the first network element to register with the NRF, and
wherein the third registration request further comprises at least one of: an internal service area of the first network element, the address of the first network element, or an address of the NEF.

16. A second network element, comprising:
a transceiver;
a memory configured to store executable instructions; and
a processor configured to execute the executable instructions stored in the memory to cause the transceiver to:
obtain first identification information of a first network element serving a terminal device; and
send an Artificial Intelligence (AI) service data to the first network element based on the first identification information of the first network element,
wherein the AI service data is sent by the first network element to the terminal device.

17. The second network element according to claim 16, the processor configured to cause the transceiver to:
send a first message to the first network element based on the first identification information of the first network element,
wherein the first message comprises second identification information of the terminal device and the AI service data.

18. The second network element according to claim 17, the processor configured to cause the transceiver to
send a second message to a Network Exposure Function (NEF),
wherein the second message comprises the first identification information of the first network element, the second identification information of the terminal device and the AI service data, and
wherein the first identification information of the first network element is used for the NEF to send a third message to the first network element, wherein the third message comprises the second identification information of the terminal device and the AI service data.

19. The second network element according to claim 16, the processor configured to cause the transceiver to:
send a first network element discovery request to a Network Repository Function (NRF), wherein the first network element discovery request comprises second identification information of the terminal device; and
receive a first network element discovery response sent by the NRF, wherein the first network element discovery response comprises the first identification information of the first network element,
wherein the first identification information of the first network element is information of the first network element having a mapping relationship to the second identification information of the terminal device obtained from a first registration information.

20. The second network element according to claim 19, the processor configured to cause the transceiver to:
send the first network element discovery request to the NRF, wherein the first network element discovery request comprises location information of the terminal device; and
receive the first network element discovery response sent by the NRF, wherein the first network element discovery response comprises the first identification information of the first network element,
wherein the first identification information of the first network element is obtained from second registration information of the location information of a service area covering the terminal device.
